(19) United States
(12) Patent Application Publication
(10) Pub. No.: US 2021/0348991 A1
(43) Pub. Date: Nov. 11, 2021

(54) COMPOSITIONS AND METHODS RELATING TO REVERSIBLY COMPRESSIBLE TISSUE-HYDROGEL HYBRIDS

(71) Applicant: Massachusetts Institute of Technology, Cambridge, MA (US)

(72) Inventors: Kwanghun Chung, Lexington, MA (US); Taeyun Ku, Seoul (KR)

(73) Assignee: Massachusetts Institute of Technology, Cambridge, MA (US)

(21) Appl. No.: 17/308,462

(22) Filed: May 5, 2021

Related U.S. Application Data
(60) Provisional application No. 63/020,499, filed on May 5, 2020.

(51) Int. Cl. G01N 1/30

(52) U.S. Cl. CPC G01N 1/30

(57) ABSTRACT

Provided herein are compositions, methods of making, and methods of use relating to reversibly compressible tissue-hydrogel hybrids.

### RELATED APPLICATIONS

This application claims the benefit of the filing date of U.S. Provisional Application No. 63/020,499, filed on May 5, 2020, the entire contents of which are incorporated by reference herein.

### FEDERALLY SPONSORED RESEARCH

This invention was made with Government support under Grant Nos. U01 MH117072 and ES027992 awarded by the National Institutes of Health (NIH). The Government has certain rights in the invention.

### BACKGROUND

Tissue transformation using synthetic hydrogels has facilitated multi-scale phenotyping of complex biological systems. Scaling this approach to larger systems, such as human organs, requires the platform to be chemically accessible and mechanically stable. Improving these two properties simultaneously, however, has been fundamentally limited by the physical nature of hydrogels.

### SUMMARY

Described herein is a technology, termed ELAST, that transforms tissues into elastic gels to enable transient and reversible shape transformation. Tissues mechanically hybridized with entangled hydrogels through slip-links become exceptionally stretchable and compressible. Mechanical thinning of the ELASTicized samples accelerates probe delivery by orders of magnitude, enabling immunolabeling of a 5 mm thick human brain tissue block within one day. ELAST offers a simple and universal platform for rapid and scalable molecular phenotyping of large-scale biological systems.

This disclosure provides compositions, methods of manufacture and methods of use relating to tissues hybridized with entangled hydrogels which become elastic and can be transiently thinned to achieve rapid molecular delivery.

Provided herein is a method of producing a tissue-hydrogel hybrid capable of reversible shape and size transformation, comprising:

(1) contacting a tissue fragment with:
(a) a high concentration of a hydrogel monomer,
(b) a low concentration of an initiator such as a thermal or radical initiator, and
(c) a low concentration of crosslinker,
   for a period of time and under conditions that allow the hydrogel monomer, initiator and crosslinker to uniformly perfuse the tissue fragment in the absence of reaction (e.g., in the absence of polymerization), and

(2) modulating the conditions in order to polymerize the monomers to each other and/or to biomolecules in the tissue fragment, and maintaining such conditions for a period of time sufficient to complete polymerization, wherein such conditions include removal or reduction of oxygen.

Provided herein is a method of producing a tissue-hydrogel hybrid capable of reversible shape and size transformation, comprising:

(1) contacting a tissue fragment, preferably at a low temperature, with:
(a) a high concentration of a hydrogel monomer,
(b) a low concentration of an initiator such as a thermal or radical initiator, and
(c) a low concentration of crosslinker, and

(2) increasing the temperature and removing oxygen, and continuing the contacting step.

Provided herein is a method of producing a tissue-hydrogel hybrid capable of reversible shape and size transformation, comprising:

(1) contacting a tissue fragment, preferably at a temperature of about 0-4° C. preferably for about 1-10 days, with:
(a) a high concentration of a hydrogel monomer,
(b) a low concentration of an initiator such as a thermal or radical initiator, and
(c) a low concentration of crosslinker, and

(2) increasing the temperature to a temperature preferably in the range of about 1-30° C. preferably for about 2 hours to 1 day, and removing oxygen.

In some embodiments, the hydrogel monomer is an acrylic monomer, optionally an acrylamide monomer. In some embodiments, the hydrogel monomer is an acrylamide monomer. In some embodiments, the initiator is a thermal initiator. In some embodiments, the thermal initiator is VA-044. In some embodiments, the crosslinker is N,N′-methylenebisacrylamide (MBAA). In some embodiments, the initiator is a radical initiator.

In some embodiments, the hydrogel monomer is present at a concentration of about 20-60% weight/volume. In some embodiments, the hydrogel monomer is present at a concentration of about 40% weight/volume.

In some embodiments, the initiator:hydrogel monomer ratio is 1:14,000. In some embodiments, the thermal initiator:hydrogel monomer ratio is 1:14,000. In some embodiments, the radical initiator:hydrogel monomer ratio is 1:14,000. In some embodiments, the crosslinker:hydrogel monomer ratio is 1:220,000. In some embodiments, the thermal initiator:hydrogel monomer ratio is 1:14,000 and the crosslinker:hydrogel monomer ratio is 1:220,000. In some embodiments, the radical initiator:hydrogel monomer ratio is 1:14,000 and the crosslinker:hydrogel monomer ratio is 1:220,000.

In some embodiments, the hydrogel monomer is acrylamide monomer and is present at 40% (wt/vol), the thermal initiator is VA-044 and is present at 0.005% (wt/vol), and the crosslinker is MBAA and is present at 0.5% (wt/vol).

In some embodiments, the hydrogel monomer is acrylamide monomer and is present at 30% (wt/vol), the thermal initiator is VA-044 and is present at 0.01% (wt/vol), and the crosslinker is MBAA and is present at 0.003% (wt/vol).

In some embodiments, the tissue fragment is about 2-5 mm thick, optionally about 2 mm thick, with lateral dimensions of 6 cm by 8 cm.

In some embodiments, the tissue fragment is a human tissue fragment, optionally a heart, colon or brain tissue fragment, optionally a cerebral organoid.

In some embodiments, the method further comprises permeabilizing the tissue fragment prior to step (1), optionally by contacting the tissue fragment with a detergent at a concentration of greater than about 0.5% wt/vol, at a temperature in the range of 20-80° C., for about 1-10 days.

In some embodiments, the detergent is a non-ionic detergent. In some embodiments, the detergent is sodium dodecyl sulfate (SDS).

In some embodiments, the tissue is not contacted with paraformaldehyde during steps (1) and (2). In some embodiments, the tissue fragment is contacted with formaldehyde before step (1).

Also provided herein is a tissue-hydrogel hybrid comprising a tissue fragment comprising:
(a) about 20-60% (wt/vol) hydrogel monomer, and
(b) an initiator, in an initiator:hydrogel monomer ratio of 1:14,000, and
(c) a crosslinker, in a crosslinker:hydrogel monomer ratio of 1:220,000.

Provided herein is a tissue-hydrogel hybrid comprising a tissue fragment comprising:
(a) about 20-60% (wt/vol) hydrogel monomer, optionally acrylic monomer, further optionally acrylamide monomer, and
(b) a thermal initiator, optionally VA-044, in a thermal initiator:hydrogel monomer ratio of 1:14,000, and
(c) a crosslinker, optionally MBAA, in a crosslinker:hydrogel monomer ratio of 1:220,000.

In some embodiments, the tissue-hydrogel hybrid comprises acrylamide monomer that is present at 40% (wt/vol), VA-044 as the thermal initiator present at 0.005% (wt/vol), and MBAA as the crosslinker present at 0.5% (wt/vol).

In some embodiments, the tissue-hydrogel hybrid comprises acrylamide monomer that is present at 30% (wt/vol), VA-044 as the thermal initiator present at 0.01% (wt/vol), and MBAA as the crosslinker present at 0.003% (wt/vol).

In some embodiments, the tissue-hydrogel hybrid has about 9-fold compression ability and/or about 10-fold stretching ability.

In some embodiments, the tissue-hydrogel hybrid has about 0-3% distortion error after either stretching or compression.

Also provided herein is a method of labeling a tissue fragment with a probe, comprising contacting any of the tissue-hydrogel hybrids described herein or produced by any method described herein with a probe, while the tissue hydrogel is repeatedly reversibly stretched, optionally in the range of 2-10-fold, and allowed to regain its original size and shape (cyclic compression), for a period of time sufficient for the probe to diffuse throughout the tissue hydrogel hybrid.

In some embodiments, the method further comprises allowing the tissue-hydrogel hybrid to regain its original size and imaging the tissue-hydrogel hybrid to visualize bound probe. In some embodiments, imaging is fluorescent microscopy imaging.

In some embodiments, the tissue-hydrogel hybrid is reversibly stretched by placing it between two parallel plates and moving the plates towards each other, thereby stretching (increasing) the tissue-hydrogel hybrid in the x and y dimensions and decreasing the tissue-hydrogel hybrid in the z dimension.

In some embodiments, the probe is a quantum dot, a peptide, a protein (optionally an antibody or antibody fragment), or a nucleic acid. In some embodiments, the probe comprises a protein comprising an antibody or antibody fragment.

These and other aspects and embodiments will be described in greater detail herein and are encompassed by this disclosure.

### BRIEF DESCRIPTION OF THE DRAWINGS

Non-limiting embodiments of the present invention will be described by way of example with reference to the accompanying Figures, which are schematic and are not intended to be drawn to scale. In the Figures:

FIGS. 1A-1C demonstrate an Entangled Link-Augmented Stretchable Tissue-hydrogel (ELAST). FIGS. 1A and 1B show schematic drawings describing two hydrogel-forming mechanisms: chemically crosslinked (FIG. 1A) and physically entangled (FIG. 1B) hydrogels. Physical slip links render the entangled hydrogel highly elastic. FIG. 1C shows a schematic illustration describing the principle of ultrafast probe delivery in ELASTicized tissue by reversible shape transformation. Biomolecular networks in an ELASTicized tissue follow the transient shape change of the synthetic entangled gel (from left to right) in a fully reversible way. The timescale (t) for probe delivery into the tissue is proportional to the square of the tissue thickness (d). Thus, transient n-fold thinning of an ELASTicized tissue can accelerate the probe delivery by n². D_{eff}, effective diffusivity.

FIGS. 2A-2C demonstrate dense entangled pAAm hydrogels that are elastic, tough, and stretchable. FIG. 2A shows that high-concentration acrylamide (AAm) solution effectively forms an entangled hydrogel in the absence of crosslinker, N,N′-methylenebisacrylamide (MBAA). FIG. 2B shows a compression test on 40% (wt/vol) pAAm hydrogels with (upper panels) and without (lower panels) 0.5% (wt/vol) MBAA. The gels were prepared with 0.005% (wt/vol) VA-044 and nitrogen gas-bubbling. Gels with 9 mm thickness were compressed to 1 mm. λ, compression strain. FIG. 2C shows a demonstration of stretching a 36% (wt/vol) entangled pAAm gel (no MBAA and 0.005% [wt/vol] VA-044 with nitrogen gas-bubbling). Representative images are shown from experiments repeated two times (FIGS. 2A and 2B) and three times (FIG. 3C) with similar results.

FIGS. 3A-3J demonstrate mechanical reinforcement and reversible shape transformation of tissue specimens via ELASTicization. FIGS. 3A and 3B show a 2 mm-thick coronal human brain hemisphere slab from the occipital pole before (FIG. 3A) and after (FIG. 3B) ELAST transformation and refractive index (RI)-matching. Scale bars, 1 cm. Experiment was repeated two times with similar results. FIG. 3C shows an ELASTicized human brain slab showing mechanical stability during sample handling and stretching. FIG. 3D shows immunolabeling of various proteins in ELASTicized 200 μm-thick human brain cortical samples, showing preserved biomolecules and tissue architecture. NF-L, neurofilament light chain. Scale bars, 40 μm. FIG. 3E shows the reversible shape transformation of an ELASTicized 1 mm-thick human brain sample upon two-fold two-dimensional (e.g., in both lateral dimensions) stretching for 1 day. A, tensile strain. Scale bar, 2 mm. FIG. 3F shows axially projected microscopic images of a pre-labeled sample before stretching and after recovery. GFAP, glial fibrillary acidic protein (a representative image from n=5 samples). Scale bars, 100 μm (insets, 20 μm). FIG. 3G shows a mean±SD plot of three-dimensional geometric deformation measured by the altered distances between feature correspondences in GFAP images at different length scales (N=5 samples). Dashed line indicates the lateral pixel size of images. RMSE, root mean squared error. FIG. 3H shows the reversible shape transformation of 1.4 mm-thick ELASTicized mouse brain samples expressing endogenous green fluorescent protein (eGFP) upon ninefold compression for at least 1 min. A, compression strain. Scale bar, 2 mm. FIG. 3I shows three-dimensionally rendered microscopic images of the sample in FIG. 3H with RI-matching (a representative image from n=5 samples). Scale bars, 500 μm (insets, 50 μm). FIG. 3J shows three-dimensional geometric deformation quantified from eGFP images (N=5 samples) (same as in FIG. 3G).

FIG. 4 shows compression of ELASTicized human brain tissue (cerebral organoid). A 4.5 mm-thick ELASTicized human brain cortical block showing resistance to a compression by 11 times. A, compression strain. Scale bar, 1 cm. Experiment was repeated two times with similar results.

FIGS. 5A-5M show thinning-mediated acceleration of probe delivery into ELASTicized tissues. FIG. 5A shows control (Ctrl) and stretched (St; two-fold in both lateral dimensions) entangled pAAm gels. Scale bar, 1 cm. The darker gray central region in each image indicates the same area, before (left) and after (right) stretching. FIG. 5B shows thickness (mean±SE) change after stretching for 22.5 min (N=4 gels; two-tailed paired t-test, ***P<0.0001, t=104). FIG. 5C shows delivery of 150 kDa fluorescein isothiocyanate (FITC)-dextran into control and stretched gels for 45 min. Laterally central regions of top halves of gels were imaged and shown with lateral projections. Stretching was released before taking images. FIG. 5D shows means±SD of depth-wise relative FITC fluorescence (N=4 gels for each group). Dashed lines show means of modeled fits (R² [mean±SD], 1.00±0.0011 for Ctrl and 1.00±0.0030 for St). FIG. 5E shows a comparison of diffusion timescales (means±SE) drawn from the fitted models in FIG. 5D (two-tailed unpaired t-test, ***P<0.0001, t=26). FIG. 5F shows schematic drawings of antibody delivery into tissue samples in different thinning approaches. Representative photos (10, 5, 5, and 5 tissue samples in the order shown) of ELASTicized 1 mm-thick human brain cortical samples in the conditions are shown together. Dashed and dotted lines indicate tissue and hydrogel areas, respectively. A 40% 1,2-dimethoxyethane solution was used for contraction (Co). Scale bar, 2 mm. FIG. 5G shows a comparison of thicknesses (N=10, 5, 5, and 5 tissue samples in the order shown; mean±SE; one-way analysis of variance, ***P<0.0001, F=1,310; post hoc Tukey's test yielded P<0.05 for a comparison between St and Co, and P<0.001 for other pairs). FIG. 5H shows laterally projected images of central tissue regions showing immunolabeling depths after 30 min incubation with a fluorophore-conjugated anti-GFAP antibody. A reference image was obtained by exposing a sample's cut surface to the antibody solution for 1 day and imaging the cut surface vertically. Experiments were repeated two times with similar results. FIG. 5I shows a comparison of depth-wise signal intensities among images in FIG. 5H. FIG. 5J shows a schematic drawing of a cyclic compression device. UHMW PE, ultrahigh molecular weight polyethylene. FIG. 5K shows an example of a cyclic compression protocol. Each cycle consists of a compression period for acceleration and a release period for flushing with a solution. FIG. 5L shows a three-dimensionally rendered image and selected planes, showing rapid full-depth immunolabeling of an originally 5 mm-thick human brain cortical sample using cyclic compression for 1 day. The sample was compressed to 16% thickness for 40 seconds and released for 10 seconds for each cycle. A central region of the sample was imaged after refractive index (RI)-matching. Selected plane images were individually contrast adjusted. Scale bar, 500 μm (selected planes, 200 μm). FIG. 5M shows rapid immunolabeling of neuronal cell types and projections in a human cerebral cortex. Scale bar, 200 μm.

### DETAILED DESCRIPTION

Engineering tissue properties using in situ hydrogel synthesis has enabled new approaches in interrogating structural and molecular organizations of complex biological systems (1-7). Chung et al. first demonstrated covalent fusion of tissue and polyacrylamide (pAAm) hydrogel via a chemical crosslinker, allowing preservation of tissue architecture and biomolecules in a fully cleared and delipidated tissue-gel (1). This approach, termed CLARITY, has enabled fine structural and molecular phenotyping of intact biological systems. Further engineering of various tissue-hydrogel properties has rapidly expanded the utility of the tissue-gel fusion approach. In particular, the expansion microscopy (ExM) and magnified analysis of proteome (MAP) techniques have enabled super-resolution imaging of a wide range of biomolecules and structures by physically swelling tissue-gel hybrids (3, 5, 8-10).

However, without exception these approaches suffer from the fundamental limitation of hydrogels: the inverse relationship between structural stability and permeability. To enhance the molecular accessibility of tissue-gel, its permeability needs to be increased, which inevitably causes loss of mechanical stability and structural information. Structural stability of tissue-gel can be enhanced by increasing the degree of crosslinking and gel density. Such increased density of the hydrogel, however, decreases its permeability and limits the penetration of molecular probes. These innate properties of hydrogels have fundamentally restricted the application of the tissue-gel fusion approach to relatively small biological systems, such as fly brain, zebrafish, rodent brain, and small blocks of human tissues. The difficulty associated with using these methods for assessment in order to evaluate complex patterns of connections in large samples of human tissues, particularly human brain, prompted a search for novel approaches.

The present disclosure describes a new class of tissue-hydrogel that offers unprecedented structural stability while enabling ultrafast transport of molecular probes. The present inventors hypothesized that elasticizing tissue would not only render it mechanically durable, but also would allow for transient and reversible shape transformation to facilitate molecular access. Well-known elastic hydrogel types (11) include (1) hydrogels having a unique polymer chain and crosslinker structure, such as polyrotaxane gels (12, 13), and (2) double-network hydrogels (14, 15), such as an interpenetrating network between pAAm and alginate gels (16, 17). These gels offer impressive mechanical properties such as stretchability and toughness, but their syntheses are not suitable for hybridization with biological tissues. For instance, their polymer units are too large to diffuse uniformly into thick tissues prior to gel formation.

This disclosure therefore provides compositions of matter comprising tissue-hydrogel hybrids, methods of making such hybrids, and methods of use of such hybrids. For the sake of convenience, the tissue-hydrogel hybrids of this disclosure may be referred to simply as “hybrids”.

Tissue-Hydrogel Hybrids

As used herein, “tissue-hydrogel hybrid” refers to a tissue fragment bound to hydrogel monomers, thereby forming a semi-solid polymer comprising hydrogel monomers bound to each other and/or tissue components.

The tissue-hydrogel hybrids of this disclosure are capable of reversible size and shape transformation. Unlike previous size-adjustable hybrids, the hybrids of this disclosure can be reversibly mechanically transformed in size and/or shape, without significant, if any, distortion. Additionally, the hybrids of this disclosure may be transformed differentially in each of the x, y and z dimensions (i.e., transformed in a non-uniform or non-linear manner across all dimensions). Hybrids of the prior art were shown to be capable of “swelling” under certain aqueous conditions, and such swelling resulted in expansion of the hydrogel across all dimensions (x, y and z) without significant non-uniform distortion of the swelled product in any one or two dimensions. Those same hybrids were further shown to substantially regain their original conformation (size and shape) once the aqueous condition was removed. The hybrids of this disclosure, however, can be subjected to mechanical forces that increase one or two dimensions, typically the x and/or y (lateral) dimensions, and decrease another dimension, typically the z (depth or thickness) dimension. The hybrids are therefore considered to be “stretchable” or “elasticizable” or “elastic” or “compressible,” because they can be pulled or compressed across various axes, thereby increasing some dimensions and decreasing others, but can then substantially regain their original form once such mechanical forces are removed.

As used herein, the term “non-linear” indicates that the expansion experienced by the hydrogel occurs to significantly different degrees in various dimensions or directions. As used herein, the term “compression” means that a hybrid may be compressed in one dimension, such as the z (depth or thickness) dimension, which reduces that dimension but in turn increases the x and y dimensions at the same time (i.e., non-linearly). The Examples illustrate one way in which this is done, which involves placing the hydrogel between two parallel flat surfaces, such as flat plates, and moving such surfaces towards each other and thus towards the hybrid. As the plates move towards each other, they will apply force to the z dimension, thereby “thinning” the hybrid and expanding it in the x and y dimensions.

The hybrids may be subject to such compression repeatedly (i.e., the steps of (1) application of mechanical force in order to “thin” the hybrid followed by (2) withdrawal of mechanical force in order to regain, in whole or in part, the original hybrid size, may be repeated 2, 3, 4, 5, 6, 7, 8, 9, 10, 15, 20, 25, 30, or more times). The disclosure contemplates that the repeated compression cycles (where one cycle consists of application of mechanical force followed by withdrawal of mechanical force) may be used in immediate succession or may be spaced apart by hours, days, weeks, or longer as the analysis of such hybrid is required. In some embodiments, the repeated compression cycles are performed in immediate succession. In some embodiments, the repeated compression cycles are spaced apart. In some embodiments, the repeated compression cycles are spaced apart by about 10 minutes, about 20 minutes, about 30 minutes, about 40 minutes, about 50 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours (i.e., 1 day), about 2 days, about 3 days, about 4 days, about 5 days, about 6 days, about 7 days (i.e., 1 week), about 2 weeks, about 3 weeks, about 4 weeks, about 5 weeks, about 6 weeks, about 7 weeks, about 8 weeks, about 9 weeks, about 10 weeks, about 11 weeks, about 12 weeks, about 13 weeks, about 14 weeks, about 15 weeks, about 16 weeks, about 17 weeks, about 18 weeks, about 19 weeks, or about 20 weeks.

As will be discussed in greater detail herein, one major advantage of the ability to compress the hybrids of this disclosure is the ability to facilitate the perfusion of the hybrid with a probe, such as an antibody. The disclosure contemplates a method in which the hybrid undergoes a compression cycle one or more times in the presence of probe in order to perfuse the hybrid with the probe. As shown in the Examples, a compressed hybrid is more rapidly perfused with probe as compared to its uncompressed counterpart. Thus, the methods of this disclosure find particular applicability in the analysis of thicker tissue fragments which would otherwise not be fully perfused with probe in a reasonable period of time, if they could be perfused with a probe at all.

The degree to which the hydrogels regain their original form is measured by a distortion error. The distortion error may be determined by measuring the distance between two or more landmarks (e.g., specific cells, vasculature, etc.) in the hybrid both before the mechanical force is applied and after the mechanical force is removed, and determining the difference between those distances. The error may then be expressed as the ratio or percentage of difference to the original distance. Another way of measuring distortion error may involve determining the location of one or more landmarks (e.g., specific cells, vasculature, etc.), optionally relative to each other or to other reference landmarks, and measuring the change in location of such landmarks, and again expressing the error as the percent change or as average change in location.

The hybrids of the invention may be compressed or stretched and then allowed to regain their original forms with distortion errors in the range of about 0-10%, or about 0-5%, or about 0-3%, or about 0-2%, or about 0-1%. In some embodiments, the distortion error is 0%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, about 5.1%, about 5.2%, about 5.3%, about 5.4%, about 5.5%, about 5.6%, about 5.7%, about 5.8%, about 5.9%, about 6%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, about 8%, about 8.1%, about 8.2%, about 8.3%, about 8.4%, about 8.5%, about 8.6%, about 8.7%, about 8.8%, about 8.9%, about 9%, about 9.1%, about 9.2%, about 9.3%, about 9.4%, about 9.5%, about 9.6%, about 9.7%, about 9.8%, about 9.9%, or about 10%.

Methods of Manufacturing Tissue-Hydrogel Hybrids

The tissue-hydrogel hybrids of this disclosure are made by contacting a tissue fragment with hydrogel monomers, an initiator such as a thermal or a radical initiator, and a crosslinker, at particular ratios. The tissue fragment may be immersed in the hydrogel monomers, initiator and crosslinker.

The hydrogel monomers are present in vast excess, typically in the range of 20-70% weight by volume (wt/vol), including 30-60%, 30-50%, about 30%, about 35%, about 40%, about 45%, and about 50% wt/vol. In some instances, the hydrogel monomer is present at about 30% to about 40%, or about 40% or about 50% wt/vol. These concentrations are considered “high concentrations” in the context of this disclosure. In some embodiments, the hydrogel monomer is present at about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, or about 70% wt/vol.

As used herein, “hydrogel monomers” are molecules that are capable of binding to each other and/or to tissue to form a hydrogel. In some embodiments, the hydrogel monomers are bound to each other and minimally bound to tissue. The hydrogel monomers may be acrylic monomers, such as, for example, an acrylamide monomer. Another acrylic monomer that may be used is sodium acrylate. Combinations of acrylic monomers may be used, such as a combination of acrylamide and sodium acrylate.

In some embodiments, the tissue fragment is contacted with an initiator. The disclosure contemplates the use of a variety of initiators, such as, but not limited to, thermal initiators. Thermal initiators are compounds that generate radicals or cations upon exposure to heat. An exemplary thermal initiator is 2,2′-Azobis[2-(2-imidazolin-2-yl)propane]dihydrochloride, commercially available as VA-044 (CAS RN 27776-21-2). VA-044 is a non-nitrile, cationic water-soluble azo polymerization initiator. In some embodiments, an initiator comprises a radical initiator. In some embodiments, a radical initiator comprises an azo compound, such as 2,2′-azobis(isobutyronitrile) (AIBN), or an organic peroxide, such as benzoyl peroxide (BPO). In some embodiments, a thermal initiator comprises a cation initiator. In some embodiments, a cation initiator comprises a benzenesulfonic acid ester, or an alkylsulfonium salts. Other initiators include ammonium persulfate, TEMED, or a combination of ammonium persulfate and TEMED.

In some embodiments, the initiator (e.g., the thermal initiator or the radical initiator) is present at much a lower concentration, relative to the concentration of the hydrogel monomer. In some embodiments, the initiator (e.g., thermal initiator or radical initiator) is present at a concentration that results in an initiator (e.g., thermal initiator or radical initiator) to hydrogel monomer ratio in the range of about 1:10,000 to about 1:20,000, including about 1:11,000, about 1:12,000, about 1:13,000, about 1:14,000, about 1:15,000, about 1:16,000, about 1:17,000, about 1:18,000, about 1:19,000, or about 1:20,000. In some instances, a thermal initiator to hydrogel monomer ratio is about 1:14,000. In some instances, a radical initiator to hydrogel monomer ratio is about 1:14,000. These concentrations are considered “low concentrations” of an initiator (e.g., a thermal initiator or a radical initiator), in the context of this disclosure.

In some embodiments, the tissue fragment is contacted with a crosslinker. Crosslinking reagents (or “crosslinkers”) are molecules that contain two or more reactive ends capable of chemically attaching to specific functional groups (e.g., primary amines, sulfhydryls, etc.) on proteins or other molecules. The disclosure contemplates the use of a variety of crosslinkers such as bis-acrylamide and variants thereof. One exemplary crosslinker is N,N′-methylenebisacrylamide (MBAA).

In some embodiments, the crosslinker is present at a much lower concentration, relative to the concentration of the hydrogel monomer. In some embodiments, the crosslinker is present at a concentration that results in a crosslinker to hydrogel monomer ratio in the range of about 1:170,000 to about 1:270,000, or in the range of about 1:200,000 to about 1:250,000, or in the range of about 1:210,000 to about 1:230,000, including about 1:170,000, about 1:180,000, about 1:190,000, about 1:200,000, about 1:210,000, about 1:220,000, about 1:230,000, about 1:240,000, about 1:250,000, about 1:260,000, or about 1:270,000. In some instances, the crosslinker to hydrogel monomer ratio is about 1:220,000. These concentrations are considered “low concentrations” of crosslinker, in the context of this disclosure.

The method involves simultaneously contacting a tissue fragment with a high concentration of a hydrogel monomer, a low concentration of initiator (e.g., thermal initiator or a radical initiator), and a low concentration of crosslinker. The aim of this step is to disperse, preferably uniformly disperse, the hydrogel monomer, initiator and crosslinker throughout the tissue fragment. This first step may be performed at a temperature in the range of about 0-4° C. including about 0° C., about 1° C., about 2° C., about 3° C., or about 4° C. This first step may be performed for a variety of times including for about 1-10 days, about 1 day, about 2 days, about 3 days, about 4 days, about 5 days, about 6 days, about 7 days, about 8 days, about 9 days, or about 10 days, or more. The length of time will depend typically on the size of the tissue fragment, with smaller fragments requiring less time and larger fragments requiring more time. The parameters of the first step may be modulated in order to uniformly disperse the hydrogel monomer(s) throughout the tissue fragment.

The first step is followed by a second step in which the temperature is increased, and the oxygen is removed. The aim of this second step is to cause the monomers to hybridize, thereby creating the hydrogel and the tissue-hydrogel hybrid. The second step is performed at a temperature in the range of about 1-30° C., including about 5-30° C., about 10-30° C., about 15-30° C., about 20-30° C., about 25-30° C., or about 20-25° C. This second step may be performed for a variety of times including for about 2 hours to 1 day, including about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours (e.g., 1 day), or for about 2-20 hours, about 4-16 hours, about 6-14 hours, or about 8-12 hours. The length of time will depend typically on the size of the tissue fragment with smaller fragments requiring less time and larger fragments requiring more time. The second step also involves removing oxygen from the mixture. Methods for removing oxygen include degassing or nitrogen gas purge.

In some embodiments, paraformaldehyde is not added during steps (1) and (2). Thus, these steps may be considered to be free of paraformaldehyde, intending that it is not added during these steps.

In some embodiments, the hydrogel monomer is acrylamide monomer, the thermal initiator is VA-044, and the crosslinker is N,N′-methylenebisacrylamide (MBAA). In some embodiments, the acrylamide monomer is present at about 30 to 40% weight/volume, the thermal initiator is VA-044 and is present in a thermal initiator:hydrogel monomer ratio of about 1:14,000, and the crosslinker is N,N′-methylenebisacrylamide (MBAA) and is present in a crosslinker:hydrogel monomer ratio of about 1:220,000.

In some embodiments, the hydrogel monomer is acrylamide monomer and is present at 40% (wt/vol), the thermal initiator is VA-044 and is present at 0.005% (wt/vol), and the crosslinker is MBAA and is present at 0.5% (wt/vol).

In some embodiments, the hydrogel monomer is acrylamide monomer and is present at 30% (wt/vol), the thermal initiator is VA-044 and is present at 0.01% (wt/vol), and the crosslinker is MBAA and is present at 0.003% (wt/vol).

The tissue fragment may be provided in virtually any size or shape. In some instances, the tissue fragment is about 1 cm thick, about 0.9 cm thick, about 0.8 cm thick, about 0.7 cm thick, about 0.6 cm thick, about 0.5 cm thick, about 0.4 cm thick, about 0.3 cm thick, about 0.2 cm thick, about 0.1 cm thick, about 50 mm thick, about 45 mm thick, about 40 mm thick, about 35 mm thick, about 30 mm thick, about 25 mm thick, about 20 mm thick, about 15 mm thick, about 10 mm thick, about 9 mm thick, about 8 mm thick, about 7 mm thick, about 6 mm thick, about 5 mm thick, about 4 mm thick, about 3 mm thick, about 2 mm thick, or about 1 mm thick. The thickness will be the smallest dimension. The lateral dimensions (x and y) may be much larger including for example 1-10 cm or more, including about 1 cm, about 2 cm, about 3 cm, about 4 cm, about 5 cm, about 6 cm, about 7 cm, about 8 cm, about 9 cm, or about 10 cm. These lateral dimensions may be about equal, or they may be different.

The tissue fragment may be derived from virtually any species or organ, and may be harvested from a subject or may be generated in vitro from tissue harvested from a subject (e.g., an organoid). In important embodiments, the tissue fragment is a human tissue fragment. Tissues derived from matrix-dense organs such as heart, colon or brain are particularly amenable to the methods provided herein.

The methods of this disclosure may be applied to tissues including, but not limited to, animal and human tissue. In some embodiments, tissues are derived from companion animals such as dogs or cats, agricultural animals such as cows, sheep and pigs, rodents such as rats or mice, zoo animals, primates such as monkeys, and the like. The tissues may be an organ or a non-organ tissue, including but not limited to brain, lung, liver, kidney, and spinal cord. The tissue may be normal tissue, diseased tissue, or tissue suspected of being diseased (e.g., a tissue biopsy obtained for purposes of diagnosing a cancer or other condition). The tissues may be sectioned or whole intact tissues. Tissues or samples to be manipulated according to the methods provided herein may be obtained from in vivo or in vitro sources, and therefore include tissues or cells explanted from a subject as well as tissues or cells grown in vitro. It is to be understood that these methods are exemplary and can be used for a variety of tissues.

The tissue may be freshly explanted from a subject or it may be a fixed fragment, such as, for example, a formalin-fixed fragment. Accordingly, the fragment may be exposed to formaldehyde prior to step (1), although it is not exposed to paraformaldehyde during steps (1) or (2).

The methods may further include a step of permeabilizing the tissue fragment prior to step (1) or following step (2). Permeabilization may be serve to delipidate the tissue, thereby permeabilizing the cells within the tissue to facilitate perfusion of the probe(s). Permeabilization may involve contacting the tissue fragment with a detergent, such as a non-ionic detergent. In some embodiments, a non-ionic detergent comprises sodium dodecyl sulfate (SDS). The detergent may be present at a concentration of greater than or equal to about 0.5% wt/vol including at about 0.5%, about 0.6%, about 0.7%, about 0.8%, about 0.9%, or about 1.0% wt/vol. This permeabilization step may be carried out at a temperature in the range of about 20° C. to about 80° C., including about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., and about 80° C. This permeabilization step may be carried out for about 1-10 days, including about 1 day, about 2 days, about 3 days, about 4 days, about 5 days, about 6 days, about 7 days, about 8 days, about 9 days, or about 10 days, or more.

The tissue-hydrogel hybrids of this disclosure in some embodiments comprise a tissue fragment comprising about 20-60% (wt/vol) hydrogel monomer, a thermal initiator, in a thermal initiator:hydrogel monomer ratio of 1:14,000, and a crosslinker, in a crosslinker:hydrogel monomer ratio of 1:220,000.

In some embodiments, the tissue-hydrogel hybrids of this disclosure comprise a tissue fragment comprising about 20-60% (wt/vol) hydrogel monomer, optionally acrylic monomer, further optionally acrylamide monomer, a thermal initiator, optionally VA-044, in a thermal initiator:hydrogel monomer ratio of 1:14,000, and a crosslinker, optionally MBAA, in a crosslinker:hydrogel monomer ratio of 1:220,000.

The hybrids of this disclosure may also be characterized in terms of their compressibility or their stretchability. “Compressibility” refers to the degree to which at least one dimension, typically depth or thickness, may be decreased (followed in some embodiments by regain of original form without significant distortion error). The hybrids may be compressed about 2-fold, about 3-fold, about 4-fold, about 5-fold, about 6-fold, about 7-fold, about 8-fold, or about 9-fold, relative to their original form. “Stretchability” refers to the degree to which at least one dimension, typically an x or y dimension, may be increased (followed in some embodiments by regain of the original form without significant distortion error). The hybrids may be stretched about 2-fold, about 3-fold, about 4-fold, about 5-fold, about 6-fold, about 7-fold, about 8-fold, about 9-fold, or about 10-fold, relative to their original form. Such compression or stretching may occur with a distortion error in the range of about 0-5%, or about 0-3%, or about 0-2%, or about 0-1%, or without measurable distortion error.

Methods of Imaging

The disclosure further provides methods of labeling a tissue fragment with a probe, comprising contacting a tissue-hydrogel hybrid produced by any of the methods provided herein, or as described herein, with a probe. In some embodiments, the tissue hydrogel is repeatedly reversibly stretched or compressed, optionally in the range of 2-10-fold, and allowed to regain its original size and shape (cyclic compression), in the presence of the probe, for a period of time sufficient for the probe to diffuse throughout the tissue hydrogel hybrid.

The methods may further comprise allowing the tissue-hydrogel hybrid to regain its original size and/or shape, and imaging the tissue-hydrogel hybrid to visualize bound probe. Imaging may be carried out using fluorescent microscopy, although the methods of imaging contemplated herein are not so limited, and other detection modalities are contemplated.

In some instances, the tissue-hydrogel hybrid is reversibly stretched or reversibly compressed by placing it between two parallel plates and moving the plates towards each other, thereby stretching (e.g., increasing) the tissue-hydrogel hybrid in the x and y dimensions and decreasing the tissue hydrogel hybrid in the z dimension.

The probe may be any virtually any probe amenable to imaging or analysis of the tissue. In some embodiments, the probe is a quantum dot, a peptide, a protein, or a nucleic acid. In some embodiments, a protein comprises an antibody or antibody fragment. In some embodiments, a protein comprises a fluorescent protein, such as, for example, green fluorescent protein (GFP) or red fluorescent protein (RFP).

In some embodiments, once the tissue-hydrogel hybrid is produced according to the methods provided herein it may be analyzed for the presence and/or level of one or more markers, such as, for example, proteins, lipids, polysaccharides, nucleic acids, and complexes thereof. The presence and/or level of the one or more targets may be determined by contacting the tissue-hydrogel hybrid with probes, which may be referred to herein as “marker-specific binding partners”. As used herein, “marker-specific binding partners” may be any molecule or compound capable of binding, preferably specifically, to the target of interest in the tissue-hydrogel hybrid. It should also be possible to remove the binding partner (or destroy the binding partner) in order to facilitate successive rounds of labeling and imaging of the sample.

Such marker-specific binding partners may be applied to the tissue-hydrogel hybrid individually or in a group and/or consecutively or simultaneously. Importantly, tissue-hydrogel hybrids prepared according to the methods of this disclosure are able to undergo multiple rounds of marker-specific binding partner labeling, imaging, and marker-specific binding partner removal (or destruction) without significant or any appreciable effect on the hydrogel, the tissue architecture, or the target antigenicity.

In some embodiments, the tissue-hydrogel hybrid is not substantially degraded throughout the method. The hybrid may be exposed to binding partners, imaged, and cleared of binding partners 2, 3, 4, 5, 6, 7, 8, 9, 10 or more times, in some embodiments, and still yield accurate information (e.g., as compared to the results obtained from the first cycle of binding partner exposure and imaging).

In some embodiments, the one or more images are overlaid and aligned to obtain a composite image.

Removal of the binding partners may be accomplished in the same manner as contacting with the binding partner occurs. That is, the hybrid may be repeatedly compressed in a solution that lacks the binding partners (i.e., a wash solution), thereby perfusing the hybrid with the wash solution and diluting, and ultimately removing, the binding partner. Such washing may in some embodiments occur at an elevated temperature, in order to encourage dissociation of the binding partner from its target. In some embodiments, washing may occur in the presence of a detergent such as, for example, SDS, either with or without high temperature.

Binding partners may be, without limitation, amino acid-based or nucleic acid-based. In some embodiments, an amino acid-based binding partner is an antibody or an antigen-binding antibody fragment. Such antibodies and fragments thereof may be monoclonal antibodies. In some embodiments, an amino acid-based binding partner is a peptide aptamer. In some embodiments, a nucleic acid-based binding partner is an aptamer.

As used herein, an “antibody” includes full-length antibodies and any antigen binding fragment (e.g., “antigen-binding portion”) or single chain thereof. The term “antibody” includes, without limitation, a glycoprotein comprising at least two heavy (H) chains and two light (L) chains inter-connected by disulfide bonds, or an antigen binding portion thereof. Antibodies may be polyclonal or monoclonal; xenogeneic, allogeneic, or syngeneic; or modified forms thereof (e.g., humanized, chimeric).

As used herein, an “antigen-binding portion” of an antibody refers to one or more fragments of an antibody which retain the ability to specifically bind to an antigen. The antigen-binding function of an antibody can be performed by fragments of a full-length antibody. Examples of binding fragments encompassed within the term “antigen-binding portion” of an antibody include (i) a Fab fragment, a monovalent fragment consisting of the VH, VL, CL and CH1 domains; (ii) a F(ab′)2 fragment, a bivalent fragment comprising two Fab fragments linked by a disulfide bridge at the hinge region; (iii) a Fd fragment consisting of the VH and CH1 domains; (iv) a Fv fragment consisting of the VH and VL domains of a single arm of an antibody; (v) a dAb fragment (see, e.g., Ward, et al., Nature 341:544 546, 1989), which consists of a VH domain; (vi) an isolated complementarity determining region (CDR); or (vii) a combination of two or more isolated CDRs, which may optionally be joined by a synthetic linker. Furthermore, although the two domains of the Fv fragment, VH and VL, are coded for by separate genes, they can be joined, using recombinant methods, by a synthetic linker that enables them to be made as a single protein chain in which the VH and VL regions pair to form monovalent molecules (known as single chain Fv (scFv); see, e.g., Bird, et al., Science 242:423 426, 1988; and Huston, et al., Proc. Natl. Acad. Sci. USA 85:5879-5883, 1988). Such single chain antibodies are also encompassed within the term “antigen-binding portion” of an antibody. These antibody fragments are obtained using conventional techniques known to those with skill in the art, and the fragments are screened for utility in the same manner as are intact antibodies.

As used herein, a “peptide aptamer” refers to a molecule with a variable peptide sequence inserted into a constant scaffold protein (see, e.g., Baines I C, et al., Drug Discov. Today 11:334-341, 2006).

As used herein, a “nucleic acid aptamer” refers to a small RNA or DNA molecule that can form secondary and tertiary structures capable of specifically binding proteins or other cellular targets (see, e.g., Ni X, et al., Curr Med Chem. 18(27): 4206-4214, 2011).

Typically, these binding partners will themselves be labeled with detectable labels. The detectable labels may be fluorophores. Examples of fluorophores include, without limitation, xanthene derivatives (e.g., fluorescein, rhodamine, Oregon green, eosin and Texas red), cyanine derivatives (e.g., cyanine, indocarbocyanine, oxacarbocyanine, thiacarbocyanine and merocyanine), naphthalene derivatives (e.g., dansyl and prodan derivatives), coumarin derivatives, oxadiazole derivatives (e.g., pyridyloxazole, nitrobenzoxadiazole and benzoxadiazole), pyrene derivatives (e.g., cascade blue), oxazine derivatives (e.g., Nile red, Nile blue, cresyl violet and oxazine 170), acridine derivatives (e.g., proflavin, acridine orange and acridine yellow), arylmethine derivatives (e.g., auramine, crystal violet and malachite green), and tetrapyrrole derivatives (e.g., porphin, phthalocyanine and bilirubin). Other detectable labels may be used in accordance with the present disclosure, such as, for example, gold nanoparticles or other detectable particles or moieties.

When two or more marker-specific binding partners are used simultaneously, it may be preferable to label such marker-specific binding partners with labels that are spectrally distinct (i.e., that can be distinguished from another label being used simultaneously).

Virtually any target of interest may be imaged using the methods provided herein provided a suitable marker-specific binding partner exists. Exemplary targets and binding partners are provided in Table 1. The targets may be found in various locations including, without limitation, at the membrane (e.g., membrane bound), in the cytoplasm, in organelles such as, but not limited to, the nucleus, and/or at synapses (in the case of neural cells), and the like.

The following Examples are included for purposes of illustration and are not intended to limit the scope of the invention. As will be apparent to one of ordinary skill in the art, the present invention will find application in a variety of compositions and methods.

### EXAMPLES

Materials and Methods

Reagents and Reagent Preparation

Solutions for making pAAm hydrogels were prepared using AAm (A9099; Millipore Sigma, St. Louis, Mo., USA), 2% MBAA solution (161-0142, Bio-Rad Laboratories, Hercules, Calif., USA), and VA-044 (Wako Chemicals, Richmond, Va., USA). A 10% (wt/vol) VA-044 stock solution was prepared in deionized (DI) water, aliquoted, and kept at −20° C. Frozen VA-044 stock aliquots were thawed and used only during the same day. For in vitro experiments, the gel monomers and the VA-044 stock solution were directly dissolved in DI water as needed. For ELAST tissue preparation, an ELAST stock solution without VA-044 was prepared in DI water (0.1% volume was left to add the VA-044 stock solution later) with 30% (wt/vol) AAm, 0.0003% MBAA (using 2% solution), 0.2% (wt/vol) Triton X-100 (0694; VWR Scientific, Pittsburgh, Pa., USA) using a 10% (wt/vol) stock solution in DI water, and 1× phosphate-buffered saline (PBS) using Gibco 10×PBS (70011-044; Life Technologies, Carlsbad, Calif., USA). The ELAST stock solution was kept at 4° C. for up to 6 months and added by 0.1% volume of the VA-044 stock solution for each use to make a final ELAST solution with 0.01% (wt/vol) VA-044. SHIELD perfusion and Off solutions were prepared using polyglycerol 3-polyglycidyl ether (GE38) provided by CVC Thermoset Specialties of Emerald Performance Materials (20). SHIELD perfusion solution was prepared with 2.5% (wt/vol) GE38 and 4% paraformaldehyde (PFA) using a 32% solution (15714-S; Electron Microscopy Sciences, Hatfield, Pa., USA) in 0.1 M sodium phosphate (diluting 1 M sodium phosphate buffer [P2072; Teknova, Hollister, Calif., USA]) and 50 mM sodium chloride (diluting 5 M sodium chloride [S5845, Teknova]). A supernatant was collected and used by vortexing the solution for 1 min and repeating (1) centrifugation for 10 min at 4° C. and 7,200 r.c.f. and (2) collecting a supernatant until the supernatant is clear. SHIELD-Off solution was prepared by omitting PFA from SHIELD perfusion solution. SHIELD-On solution was prepared by combining 2 mL of 1 M sodium carbonate (S7795, MilliporeSigma) with 0.02% (wt/vol) sodium azide, 2 mL of 1 M sodium bicarbonate (S5761, MilliporeSigma) with 0.02% (wt/vol) sodium azide, and 36 mL of DI water. A clearing solution was prepared by dissolving 6% (wt/vol) sodium dodecyl sulfate (75746, MilliporeSigma), 50 mM sodium sulfite (S0505, MilliporeSigma), and 0.02% (wt/vol) sodium azide (S2002, MilliporeSigma) in 0.1 M phosphate buffer, and the pH was adjusted to 7.4. Washing solutions were prepared as 0.1% (wt/vol) Triton X-100 in PBS (diluting 10×PBS [P0496, Teknova]) either with (PBST) or without (PBST without azide) 0.02% (wt/vol) sodium azide. PBS with 0.02% (wt/vol) sodium azide (PBS with azide) was also used as a washing solution. A blocking solution was prepared by adding 5% volume of normal goat serum (ab7481; Abcam, Cambridge, Mass., USA) to PBST. See Table 1 for antibody and probe purchase and usage. A 1,2-dimethoxyethane solution was prepared by mixing 1,2-dimethoxyethane (307432, MilliporeSigma) and PBST in a volume-to-volume ratio of 4:6. Antibody fixation solution was prepared in PBS with 4% PFA using a 32% solution and Gibco 10×PBS. AAm, MBAA, 1,2-dimethoxyethane, and PFA are toxic chemicals requiring cautions and should be handled in a chemical hood.

TABLE 1
Antibody and probe information.

| | | | Host | | Dilution |
|---|---|---|---|---|---|
| Antibody or probe | Catalog # | Vendor | species | Clonality | (μL/μL) |
| Anti-NeuN | ab104225 | Abcam^{a} | Rabbit | Polyclonal | 1:300ⁱ |
| Anti-MAP2 | 822501 | BioLegend^{h} | Chicken | Polyclonal | 1:300ⁱ |
| Anti-parvalbumin | PA1-933 | Invitrogen^{c} | Rabbit | Polyclonal | 1:300ⁱ |
| Anti-SMI-312 | 837904 | BioLegend^{h} | Mouse | Monoclonal | 2:300ⁱ |
| Anti-calretinin | ab702 | Abcam^{a} | Rabbit | Polyclonal | 1:300ⁱ |
| | | | | | 10:1,000^{m} |
| Anti-neurofilament | NFL | Aves^{d} | Chicken | Polyclonal | 3:300ⁱ |
| light chain | | | | | 60:1,000^{m} |
| Anti-calbindin | 13176 | CST^{e} | Rabbit | Monoclonal | 1:300ⁱ |
| Anti-tyrosine hydroxylase | 818001 | BioLegend^{h} | Mouse | Monoclonal | 1:300ⁱ |
| Anti-neuropeptide Y | 11976 | CST^{e} | Rabbit | Monoclonal | 1:300ⁱ |
| Anti-myelin basic protein | ab7349 | Abcam^{a} | Rat | Monoclonal | 2:300ⁱ |
| Anti-synapsin 1/2 | 106002 | SYSY^{f} | Rabbit | Polyclonal | 1:300ⁱ |
| Anti-PSD-95 | 75-028 | NeuroMab^{g} | Mouse | Monoclonal | 1:300ⁱ |
| Anti-GFAP | 8152 | CST^{e} | Mouse | Monoclonal | 10:1,000^{j,k} |
| (Alexa Fluor 594) | | | | | 50:5,000^{l} |
| Lectin | DL-1174 | Vector^{h} | Tomato | | 10:1,000^{k} |
| (DyLight 488) | | | | | |
| Anti-rabbit IgG | A32731 | Invitrogen^{c} | Goat | Polyclonal | 1:300ⁱ |
| (Alexa Fluor Plus 488) | | | | | 10:1,000^{m} |
| Anti-mouse IgG | A32728 | Invitrogen^{c} | Goat | Polyclonal | 1:300ⁱ |
| (Alexa Fluor Plus 647) | | | | | |
| Anti-chicken IgY | ab150175 | Abcam^{a} | Goat | Polyclonal | 1:300ⁱ |
| (Alexa Fluor 647) | | | | | 20:1,000^{m} |
| Anti-rat IgG | Ab150151 | Abcam^{a} | Donkey | Polyclonal | 1:300ⁱ |
| (Alexa Fluor 647) | | | | | |

^{a}Abcam (Cambridge, MA, USA).
^{b}BioLegend (San Diego, CA, USA).
^{c}Life Technologies (Carlsbad, CA, USA).
^{d}Ayes Labs (Tigard, OR, USA).
^{e}Cell Signaling Technologies (Danvers, MA, USA).
^{f}Synaptic Systems (Goettingen, Germany).
^{g}UC Davis/NIH NeuroMab Facility (Davis, CA, USA).
^{h}Vector Laboratories (Burlingame, CA, USA).
ⁱAntibody compatibility experiment with one 200-μm-thick ELASTicized human section piece.
^{j}Antibody delivery speed experiment with one ELASTicized 1-mm-thick human sample.
^{k}Stretching-related deformation with two or three ELASTicized 1-mm-thick human samples.
^{l}Immunolabeling of one ELASTicized 5-mm-thick human sample in a blocking solution.
^{m}Double-immunolabeling of an ELASTicized 1-mm-thick human sample.

Entangled Hydrogel Experiments

All hydrogels were polymerized in 50 mL conical tubes (referred to as polymerization tubes). The common preparation sequence is as follows: (1) a polymerization tube was purged with a nitrogen gas (NI UHP300; Airgas East, Salem, N.H., USA) at 12 psi for 1 min; (2) a gel solution was directly or indirectly put in the tube; (3) the tube was additionally purged with a nitrogen gas for 15 seconds and sealed using a screw cap connected to 12-psi nitrogen gas; and (4) the tube was vertically placed in a custom-built heating device. Gel solutions to confirm dense gel formation without MBAA were prepared in a fixed ratio between monomer and initiator concentrations. Gel solutions of 2 mL were prepared in 15 mL conical tubes and bubbled using a nitrogen gas-connected glass capillary (1B100E-4; World Precision Instruments, Sarasota, Fla., USA) at a low gas pressure for 1 min. The solutions (1 mL) were transferred to polymerization tubes. Low-concentration (4% [wt/vol] AAm with and without 0.05% [wt/vol] MBAA) solutions with 0.04% (wt/vol) VA-044 were polymerized at room temperature (RT), and high-concentration (40% [wt/vol] AAm with and without 0.5% [wt/vol] MBAA) solutions with 0.4% (wt/vol) VA-044 were polymerized on ice to avoid runaway heat generation. The tubes were left for 1 day and photos were taken. To test compression, the top of each 15 mL conical tube was cut into a 2 cm-long cylinder, and the original top was super-glued to a squared #1 coverslip (48393070, VWR Scientific). Gel solutions (40% [wt/vol] AAm and 0.005% [wt/vol] VA-044 with and without 0.5% [wt/vol] MBAA) of 2 mL were prepared in 15 mL conical tubes and nitrogen gas-bubbled for 1 min. The solutions (1.5 mL) were transferred to the cut cylinders. The cylinders were put in polymerization tubes. Polymerization was completed at 37° C. after about 15 min, and the tubes were kept overnight for stabilization. Gels of 9 mm thickness were collected, and each was placed on a vise jaw. Two fragments of 1 mm-thick slide glasses were left on the jaw as a thickness guide. The vice was tightened and then released as a compression demonstration. To test stretching, 2 mL gel solutions (5 M AAm and 0.005% [wt/vol] MBAA) were prepared, transferred to 1 mL syringes (SS-01T; Fisher Scientific, Pittsburgh, Pa., USA), and nitrogen gas-bubbled for 1 min. Each syringe was sealed with Parafilm and covered with a Blu-Tack adhesive (Bostik, Essendon Fields, Victoria, Australia) ball. The syringes were put in polymerization tubes filled with DI water and polymerized and stabilized at 35° C. for 1 day. The syringes were cut, and the gels were taken out and used for a stretching demonstration.

Diffusion Experiment and Modeling Using Hydrogels

Two millimeter-thick cartridges were made of two 1 mm-thick slide glasses spaced by super-gluing four stacks of two slide glass fragments near the four edges. The lateral and bottom edges were taped, and further secured with super-glue. A gel solution of 30% (wt/vol) AAm, 0.0003% (wt/vol) MBAA, and 0.01% (wt/vol) VA-044 in DI water was poured into the cartridges and polymerized in polymerization tubes at 33° C. for 6 hours. After swelling extracted gels in excess DI water at 37° C. for 3 days with daily exchange for fresh water, swollen 4 mm-thick gel slabs were cut into squares (2 cm by 2 cm). Any top regions having less swollen sizes were excluded. A stretching apparatus was made with four 56 mm-long, 1.6 mm-diameter stainless steel rods (cut from 1263K24 [McMaster-Carr, Princeton, N.J., USA]) and four 38 mm-long tube pieces cut from polypropylene 1,250 μL pipette tips having two holes in a 32 mm-long interval. Each of the squared gels was first pierced using 25-gauge syringe-needles (305125; BD, Franklin Lakes, N.J., USA) along the four lateral edges in 16 mm-long intervals, then the rods were inserted into these piercings, and finally the gels were stretched with the aid of the pipette tip pieces. A micrometer (395-371-30; Mitutoyo America, Aurora, Ill., USA) was used to measure the thicknesses of unstretched gels and stretched gels after immersing in PBST for 22.5 min. Each thickness was measured three times, and a median was chosen.

A 150 kDa FITC-dextran (FD150S, MilliporeSigma) stock solution was prepared at 10 mg mL⁻¹ in DI water, aliquoted, and frozen at −20° C. An FITC-dextran solution in PBST was freshly prepared at 0.2 mg mL⁻¹ using the stock solution. Control and stretched gels were incubated in 40 mL FITC-dextran solutions on a gentle shaker for 45 min at room temperature (RT). The stretched gels were recovered by removing the apparatus immediately after the incubation. Each of the stained gels was mounted in an imaging chamber made of a slide glass, a WillCo dish (HBSB-5030; WillCo Wells, Amsterdam, Netherland), and two spacers using four slide glasses. The topmost 3 mm thickness of a central region (0.3 mm by 0.3 mm) of the mounted gel was imaged using the Olympus FV1200MPE laser-scanning confocal microscope with a 10×, 0.3-numerical aperture (NA) water-immersion objective (UMPLFLN 10XW) and a 488 nm argon laser. Mounting and imaging was completed within 3 min. The fluorescence signals were subtracted by depth-wise background signals obtained from an unstained gel imaged in the same way.

A one-dimensional transient diffusion model was used to fit the FITC-dextran distribution profiles:

$$\frac{\partial }{\partial t} C ( x , t ) = {D}_{eff} \frac{{\partial }^{2}}{\partial {x}^{2}} C ( x , t ) ,$$

where C(x, t) is the non-dimensional relative FITC-dextran concentration at depth x at time t and D_{eff} is the effective diffusion coefficient. Because of symmetry, the lower half of the gel was assumed to have a mirror distribution of the upper half. The initial and boundary conditions for the partial differential equation are:

$$C ( 0 , t ) = 1 , \\ \frac{\partial }{\partial x} C ( T , t ) = 0 , \\ C ( 0 < x \leq T , 0 ) = 0 ,$$

where T is the half-thickness of a gel. The equation was numerically solved using custom MATLAB (R2016a; MathWorks, Natick, Mass., USA) scripts to derive D_{eff} using least-squares curve fitting. The surface data points showing reduced concentration possibly due to regurgitation were excluded from the fitting and then reconstructed from the fitted solution for display. Obtained D_{eff} values were converted to relative dimensionless diffusion timescale for a comparison.

Preparation of Human Brain Samples

About 1 cm-thick coronal human brain hemisphere slabs in a formalin solution were obtained from Massachusetts General Hospital (Boston, Mass., USA). The formalin solution was replaced with PBS with azide, and the slabs were stored at 4° C. until use. Whole-area coronal hemisphere slabs of 2 mm thickness were obtained by microtome-sectioning of the original thick slabs using a custom-built flexure-based vibrating-blade microtome (21). Each of the thick slabs was embedded in a 1.5% (wt/vol) agarose gel in PBS, where any gel on the bottom surface was removed, and super-glued on a glass plate. The glass plate was super-glued on a microtome chamber, and the chamber was filled with PBS. A frequency of 60 Hz and a blade propagation speed of 0.3 mm s⁻¹ were used. For large tissue blocks used for compression testing and thick-tissue labeling, cortical regions were manually cut using a razor blade to include a thickness of up to 5 mm from the pial surface. Horizontal tissue samples of 1 mm thickness used for antibody delivery comparison and stretching-related deformation analysis were obtained by vibrating-blade microtome (VT1200; Leica Biosystems, Nussloch, Germany)-slicing of several millimeters-thick horizontal cortical blocks that were manually cut. The pial surface region (200-300 μm thickness) of each sample was trimmed off. The obtained 1 mm-thick samples were manually cut into square pieces (2 mm by 2 mm). A coronal slice having an original thickness of about 1.5 mm was used for the antibody compatibility test.

ELASTicization of Archived Human Brain Specimens

The long-term formalin-fixed human tissue samples were first strongly permeabilized by means of intermediate chemical clearing using a clearing solution in 50 mL conical tubes at 70° C. overnight. Samples thicker than 1 mm were additionally cleared with a fresh clearing solution at 56° C. until the apparent clearing front disappeared. Samples of 5 mm thickness were cleared for 5 days, and 2 mm-thick whole-area slabs were cleared for 5-9 days. Cleared samples were washed with PBST without azide at 37° C. for 6 hours (1 mm-thick samples), 3 days (5 mm-thick samples), or 4-5 days (2 mm-thick slabs) with exchanging the solution every 1 or 2 days. At this point, it is important to ensure the removal of most of the azide and sulfite from the tissues, because these chemicals quench radicals during AAm polymerization and impede gel formation. Samples were then incubated in an ELAST solution at 4° C. overnight (1 mm-thick samples), for 5 days (5 mm-thick samples), or for 8-9 days (2 mm-thick slabs). Other than for large-area slabs, polymerization cartridges were prepared using two 1 mm-thick slide glasses spaced at four edges by super-glued stacks of slide glass and coverslip fragments that match the thickness of each sample in the ELAST solution. After taping with transparent plastic tape along lateral and bottom edges and then tailoring and super-gluing the tape, samples were inserted into the cartridges. The space in each cartridge was filled carefully with the same ELAST solution used to incubate the tissues, ensuring that there are no apparent bubbles. The cartridges were put in 50 mL conical tubes that were pre-purged with a nitrogen gas at 12 psi for 1 minute. The tubes were then additionally purged for 15 seconds and sealed with screw caps connected to a nitrogen gas at 12 psi. The tubes were placed in a custom-built heating device at an angle of approximately 15°. Samples of 1 mm thickness were polymerized at 35° C. for 6 hours, and 5 mm-thick samples were polymerized in a sequence of 35° C. for 1 hour, 28° C. for 1 hour, 27° C. for 1.5 hours, 26° C. for 2.5 hours, and 35° C. for 0.5 hours to avoid rapid polymerization triggered by abrupt heat generation, which hinders sufficient entanglement promoted by slow movement of growing pAAm chains. In a cold environment, each 2 mm-thick hemisphere slab incubated in ELAST solution was placed on a glass plate (260232; Ted Pella, Redding, Calif., USA) having super-glued 2 mm-thick spacers (stacks of two slide glass fragments) at four corners of the plate. Another glass plate was first placed on top of the sample at a height of 3 mm, guided by two stacks of three slide glasses. Then, the space above the sample was filled with the same solution, and the cover plate was lowered to 2 mm height. The glass plates were taped, leaving a small opening at one corner, and sealed using a super-glue, which was cured at 4° C. The cartridge space was filled with the same solution using a 20 mL needle-syringe while avoiding bubble-trapping. The cartridge was placed in a plastic bag with a zipper lock. The bag was purged with nitrogen gas at 12 psi for 10 minutes, closed, placed in a water bath where the temperature was maintained at 33° C., and polymerized and stabilized overnight. Embedded samples were cut from the gels using a razor blade to have adequate gel margins and cleared in a clearing solution at 37° C. overnight (1 mm-thick samples) or at 56° C. for 5 days (5 mm-thick samples) or 2 days (2 mm-thick slabs, in a 500 mL glass bottle) with exchanging the solution every 1 or 2 days. Fully cleared samples were washed with PBST at 37° C. for 6 hours (1 mm-thick samples) or 3 days (other samples) with exchanging the solution 2 or 3 times. Swollen gels containing samples for the antibody delivery speed comparison were cut into squares (6 mm by 6 mm) using a razor blade so as to have one tissue sample for each square at the center. Thick samples used for compression testing and thick-tissue labeling were carefully isolated from the surrounding gels.

Preparation and ELASTicization of Mouse Brain Samples

All experimental protocols were approved by the MIT Institutional Animal Care and Use Committee and the Division of Comparative Medicine and were in accordance with guidelines from the National Institute of Health. All experiments using mice were conducted in strict adherence to the ethical regulations of MIT Institutional Animal Care and Use Committee and the Division of Comparative Medicine. Thy1-GFP-M transgenic mice (2-4 month-old) were housed in a 12 hour light/dark cycle with unrestricted access to food and water. Mice were transcardially perfused with 20 mL of ice-cold PBS followed by 20 mL of ice-cold SHIELD perfusion solution at a flow rate of 5 mL min⁻¹. Brains were extracted and incubated in 15-20 mL of the same perfusion solution at 4° C. for 48 hours with shaking. The brains were transferred to 20 mL of pre-chilled SHIELD-Off solution and incubated at 4° C. for 24 hours with shaking. The brains were placed in 40 mL of SHIELD-On solution and incubated at 37° C. for 24 hours. SHIELD-fixed brains were washed with PBS with azide at RT overnight and split into hemispheres using a razor blade. The hemispheres were delipidated passively in a clearing solution at 37° C. for 12-14 days or 45° C. for 10 days until the opaque core disappeared. Cleared hemispheres were washed with 50 mL of PBST without azide or with 0.02% (wt/vol) thimerosal (T5125, MilliporeSigma) at 37° C. for 3 days with four solution exchanges. The hemispheres were incubated in ELAST solution at 4° C. for 5 days with daily solution exchange. One or two hemispheres were inserted into a polymerization cartridge, and polymerization was performed in a sequence of 33° C. for 1 hour, 25° C. for 4.5 hours, and 35° C. for 0.5 hours. Embedded hemispheres were cleared in a clearing solution at 37° C. for 5-7 days with solution exchange every 2 days, and then washed with PBST at 37° C. for 3-4 days with daily solution exchange. Surrounding gels were carefully removed from the hemispheres during or after washing. The 1 mm-thick mouse coronal brain hemisphere slice used for a demonstration of stretching was prepared by embedding a microtome-sectioned 1 mm-thick slice.

Thinning of ELASTicized Tissue Samples

A 4.5 mm-thick ELASTicized human sample used for the compression demonstration was placed on a 15 cm (width)×15 cm (height)×1.3 cm (thickness) glass plate (CG-1904-18; Chemglass Life Sciences, Vineland, N.J., USA) together with two spacers of approximately 0.42 mm thickness using stacks of three #1 coverslips at two lateral edges of the plate. The sample was covered with another plate and photos were taken before and after compression. The thickness of the coverslip stacks was the target final compressive thickness of the sample. ELASTicized mouse samples for the quantification of compression-related deformation were obtained from an ELASTicized mouse brain hemisphere: one hemisphere was manually cut using a razor blade to obtain a 3 mm-thick block, and this block was microtome sliced to get a 1.4 mm-thick slice; the slice was chopped into several pieces using a razor blade. Obtained pieces were compressed between two glass plates with dimensions of 75 mm (width), 51 mm (height), and 1.2 mm (thickness) (71862-01, Electron Microscopy Sciences). A #1 coverslip was placed on each of the lateral edges of the bottom glass plate to guide a tenfold compression. Samples were compressed ten times for at least one minute, and photos were taken before and after each compression.

A stretching apparatus was made with four 14.5 mm-long needles cut from 25 gauge syringe-needles and 10.5 mm-long tube pieces cut from polypropylene 10 μL pipette tips having two holes in an 8 mm-long interval. ELASTicized 1 mm-thick human samples were pierced by the needles along four lateral edges in an 8 mm-long interval and stretched with the aid of the pipette tip pieces. Samples for the quantification of stretching-related deformation were stretched overnight at 37° C. Photos were taken before stretching, after overnight stretching, and after >2 hours recovery. The thicknesses of ELASTicized 1 mm-thick human samples were measured by a micrometer 3 times, and a median was chosen for each sample. The thicknesses of stretched samples were measured after stretching followed by incubation in 2 mL PBST at room temperature (RT) for 3 hours. The thicknesses of contracted samples were measured after incubation in a 10 mL 1,2-dimethoxyethane solution at 37° C. overnight and then at RT for 6 hours for a full incubation to dismiss a transient opaqueness. After incubating stretched samples in a 5 mL 1,2-dimethoxyethane solution at RT for 1 hour, exchanging the solution, incubating at 37° C. overnight, and then at RT for 1 hour, the thicknesses of the stretched/contracted samples were measured.

Immunolabeling of Thin ELASTicized Human Brain Samples

For the antibody compatibility test, an approximately 1.5 mm-thick human brain coronal slice was ELASTicized and then microtome sliced to obtain 200 μm-thick sections. A very slow blade propagation speed (0.1 mm s⁻¹) and a very high amplitude (1 mm) were used to slice the elastic sample. The sections were cut into small pieces (about 2 mm by 2 mm) and put in a 24-well plate. Samples were incubated in PBST with primary antibodies overnight, washed with PBST three times for 2 hours each, incubated in PBST with secondary antibodies overnight, and washed with PBST twice for 2 hours each. The well plate was placed on a gentle shaker at 37° C. during the procedure. For the antibody delivery speed comparison, ELASTicized 1 mm-thick human samples were stained with a 10 μL anti-GFAP antibody conjugated with Alexa Fluor 594 in a 50 mL conical tube with 1 mL PBST on a gentle shaker at room temperature (RT) for 30 minutes. Stretched samples were put in the antibody solution immediately after stretching. Stretched/contracted samples were prepared by incubating stretched samples in a 3 mL 1,2-dimethoxyethane solution at RT for 30 minutes (exchanging the solution once after 10 minutes). After exchanging again with fresh 1 mL 1,2-dimethoxyethane solution, antibody was added. Contracted samples were prepared by incubating samples in a 3 mL 1,2-dimethoxyethane solution at 37° C. overnight (exchanging once) and then at RT for 3 hours. Antibody-stained samples were washed with PBST at RT for 30 minutes. All stretched samples were recovered from stretching and left in PBST for 30 minutes before imaging. One ELASTicized 1 mm-thick sample was used to test the compatibility of thinning methods with cell-type and projection markers. The sample was stretched twofold laterally and then antibody-stained. A 1,2-dimethoxyethane solution (35:65 volume ratio) was used for anti-neurofilament light chain antibody, and other primary and secondary antibodies were stained in PBST.

Thick-tissue Immunolabeling with Cyclic Compression

An ELASTicized 5 mm-thick human sample (lateral dimensions of 12 mm and 7 mm) was photobleached to remove autofluorescence including lipofuscin pigments. A photobleaching device was built by wrapping a 1 L glass beaker with a strip of white light-emitting diodes (Ledmo SMD5630; Shenzhen Xiangliang Lighting, Shenzhen, China). The sample in PBST was placed in the center of the horizontally positioned device at 4° C. for 3 days, then pre-blocked in a blocking solution at 37° C. for 1 day on a gentle shaker, and then kept in the same solution until antibody-staining. A cyclic compression device was custom-built using a Nema 23 bipolar stepper motor (23HS16-0084S; OSM Technology, Ningbo, China) connected to a Raspberry Pi 3 B+ motherboard (Raspberry Pi Foundation, Cambridge, UK) with a dedicated stepper motor controller (2348; Adafruit, New York, N.Y., USA). The axial movement part of the device consisted of a 60 mm cage system (two LCP02 and one LCP03; Thorlabs, Newton, N.J., USA) and custom-made polycarbonate plates. One plate was fixed in place while the other was driven with a leadscrew cut from an M6-threaded rod (1078N11, McMaster-Carr), which was coupled to the shaft of the stepper motor. A sample container bag with a width of 5.5 cm and height of 15 cm was made of an ultrahigh-molecular weight polyethylene film (85655K12, McMaster-Carr) and shaped using an impulse heat sealer. To minimize sticking of samples to the walls during a flushing cycle, the bag was vertically grooved in a 5 mm interval by alternative folding. Two films of 5.5 cm height were fused with the bag vertically along the midline using the heat sealer so as to provide wings for attaching the bag to the chamber plates. The bag was inserted into the movement chamber of the device in a 37° C. environment, and the four wings of the bag were fastened and then attached to the chamber plates using tape. The sample was put into the bag with a 5 mL blocking solution, and 50 μL antibody was added. Compression and relaxation movements operated by the stepper motor and leadscrew were remotely controlled using a Python script. For an 8 mm-thick swollen sample, the chamber was operated with a travel distance of 10 mm (starting at an 11.25 mm height and compressing to a 1.25 mm height). The travel speed was set to 2 mm s⁻¹, and the cycling time intervals were set to 40 seconds for compression/acceleration and 10 seconds for relaxation/flushing (by means of upward and downward movements). After antibody incubation for 1 day, the sample was washed with PBST at 37° C. overnight on a gentle shaker. Prior to RI-matching, the antibody in the sample was fixed by incubating in an antibody fixation solution at 37° C. for 6 hours and washing with PBS with azide twice for 2 hours each at 37° C.

RI-Matching

The whole-area human brain hemisphere slabs of 2 mm thickness, the immunostained 5 mm-thick human sample, and the 1.4 mm-thick mouse samples for the compression test were optically cleared by RI-matching. The 2 mm-thick slabs were RI matched using an immersion medium of a lower contraction power (125 g iohexol, 3 g diatrizoic acid, and 5 g N-methyl-D-glucamine dissolved in 100 mL DI water, followed by RI adjustment to 1.458 by adding DI water, and then mixing 90% volume of the medium with 10% volume of 2,2′-thiodiethanol, which yielded a final RI of 1.465). Each slab was incubated in a 100-150 mL medium in a 250 mL glass bottle at 37° C. for 1 day, exchanging the medium twice. Other samples, including the immunostained thick sample and the 1.4 mm-thick ELASTicized mouse brain samples, were RI matched using an immersion medium of a higher contraction power that restores a swollen ELASTicized tissue to near original size (an unpublished variation). Samples were incubated at 37° C. according to the following sequences: for the 5 mm-thick human sample, 10 mL of 50% medium (mixed with DI water) for 6 hours, 10 mL of 100% medium overnight, and fresh 10 mL medium for 6 hours; and for the 1.4 mm-thick samples, 1.5 mL of 50% medium for 2 hours, 1.5 mL of 100% medium overnight. Other samples including the 1 mm-thick human samples used for the antibody delivery speed comparison and the 200 μm-thick ELASTicized human brain sections used for the antibody compatibility test were imaged without an RI-matching due to sufficient transparency.

Microscopic Imaging of ELASTicized Tissues

For the antibody delivery speed comparison, two strips of Blu-Tack adhesive were placed on a slide glass, and each of the 1 mm-thick samples was put between the strips. A squared #1 coverslip was placed and gently compressed to fit the sample thickness. About 100 μL of PBST was added to prevent the sample from drying. The samples were imaged using the Olympus FV1200MPE laser-scanning confocal microscope with a 20×, 1.0-NA water-immersion objective (XLUMPLFLN 20XW) and a 559 nm diode laser. Central tissue locations were chosen to avoid misinterpretation by lateral diffusion, and longitudinal regions (8:1) were imaged along the whole depth with a constant laser power and gain parameter and then projected to xz planes using Imaris software (Bitplane, Zurich, Switzerland). For labeling and imaging of the 5 mm-thick human sample, a Blu-Tack adhesive strip was placed on a 60 mm-diameter petri dish (351007; Corning, Corning, N.Y., USA) along the sample boundary, and three Blu-Tack adhesive balls were put along the dish boundary as spacers. The sample incubated in the RI-matching medium was placed and covered by a WillCo dish with no bubble-trapping. The WillCo dish was gently compressed to match the sample thickness, and the space between the two dishes was filled with the same medium. The gap between the two dishes exposed to the air was sealed with a long Blu-Tack strip. The mounted sample was left at 37° C. for 2 hours for RI stabilization. The sample was imaged using the same Olympus microscope with a 10×, 0.6-NA CLARITY-optimized objective (XLPLN10XSVMP, 8.0-mm working distance) and a 559 nm diode laser. The objective was immersed in the same RI-matching medium poured in the WillCo dish, and imaging was started 30 minutes after installation to stabilize the RI around the objective. A central tissue region was imaged along the whole depth with a constant laser power and gain parameter. The imaged volume was three-dimensionally rendered using the Imaris software, and a video showing axial navigation was generated using ImageJ (National Institutes of Health; Bethesda, Md., USA). The thin sections used for the antibody compatibility test were mounted on slide glasses with Blu-Tack adhesive balls at four corners and covered with #1 coverslips. The space near the samples was filled with PBST. The samples were imaged using the Leica TCS SP8 laser-scanning confocal microscope with a white-light laser source for excitations at 488 nm and 647 nm. A 63×, 1.3-NA glycerol-immersion objective (HC PL APO CS2) was used for the samples stained with anti-synapsin 1/2 and anti-PSD-95 antibodies, and a 25×, 0.95-NA water-immersion objective (HCX IRAPO L) was used for other samples.

Quantification of Thinning-Related Deformation

ELASTicized human samples of original 1 mm thickness were stained with anti-GFAP antibody conjugated with Alexa Fluor 594 and tomato lectin conjugated with DyLight 488. The samples were mounted in the same manner as the samples used for the antibody delivery speed comparison and left under the same microscope setting for 0.5-2 hours until all noticeable sample movement had ceased. A 100 μm surface depth of each sample was imaged with a 2 μm z-step size using the Olympus microscope with a 20×, 1.0-NA water-immersion objective, a 488 nm argon laser, and a 559 nm diode laser. The imaged samples were stretched using the stretching apparatus and left in PBST at 37° C. overnight. The samples were then released from stretching and recovered in PBST at room temperature (RT) for 1-2 hours. The samples were mounted, stabilized, and imaged in the same way. The GFAP channel was used for quantitative analysis using a method described previously (5). In brief, GFAP filament features of each sample were detected in three dimensions and corresponded between two images obtained before and after stretching. The correspondence information was used to generate a regularly spaced three-dimensional deformation mesh. The deformation-related distance change between each pair of mesh points was measured as an error. For each of the measurement distances, the square root of the average of squared errors was collected from each tissue sample.

ELASTicized mouse samples in 1.4 mm thickness used for the compression test were imaged before compression and after recovery. Before compression, samples were RI matched and eGFP signals were imaged using the Olympus microscope with a 20×, 1.0-NA water-immersion objective and a 488 nm argon laser. Images were three-dimensionally rendered by the Imaris software for display. Imaged samples were then recovered in PBST and subjected to the compression test while photos were taken. After the test, the samples were RI matched and imaged again. Obtained eGFP images before and after compression were quantitatively analyzed using the same method for the stretching test with human samples and GFAP images.

Statistical Analysis

Sample numbers and replication types are described in figure legends, where all replicates are either different hydrogels or different tissue samples. For the thickness measurement of hydrogels, the thicknesses of four gels were measured before and after stretching and analyzed using a two-tailed paired t-test. For the comparison of diffusions in hydrogels, eight gels were randomly assigned to either the control or stretching group. An effective diffusion coefficient was computed from each gel, and the resulting diffusion timescales were compared using a two-tailed unpaired t-test. For the thickness measurement of ELASTicized human brain samples, ten samples were collected, and their thicknesses were measured. The samples were then split into two groups of stretching and contraction-only so as to have average thicknesses as close as possible between the two groups. Thicknesses of stretched samples were measured after stretching and then after contraction, and thicknesses of contracted samples were measured after contraction. One-way analysis of variance was used to compare the thicknesses among the four groups. A post hoc Tukey's test was performed to compare thicknesses between each pair of groups. Five samples were prepared for each of the deformation analyses with stretching and compression, and images obtained before and after stretching or compression were used for error quantification. Most of other experiments, such as the antibody validation, the antibody delivery speed comparison, the stretching and RI-matching of large-area slabs, and the compression of thick samples were carried out at least twice with the same results. The thick-tissue immunolabeling with a 5 mm-thick human brain sample was performed once.

Results and Discussion

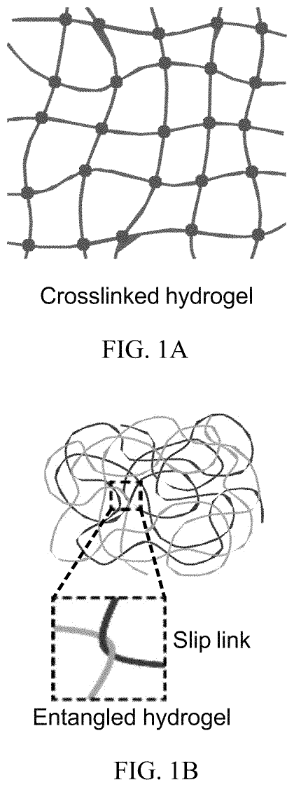

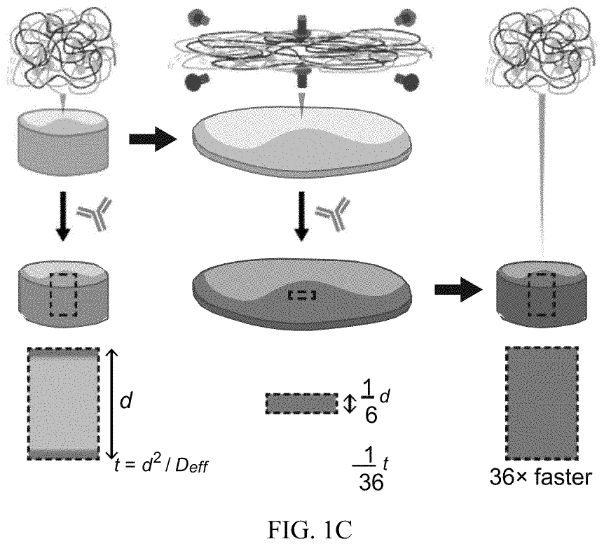

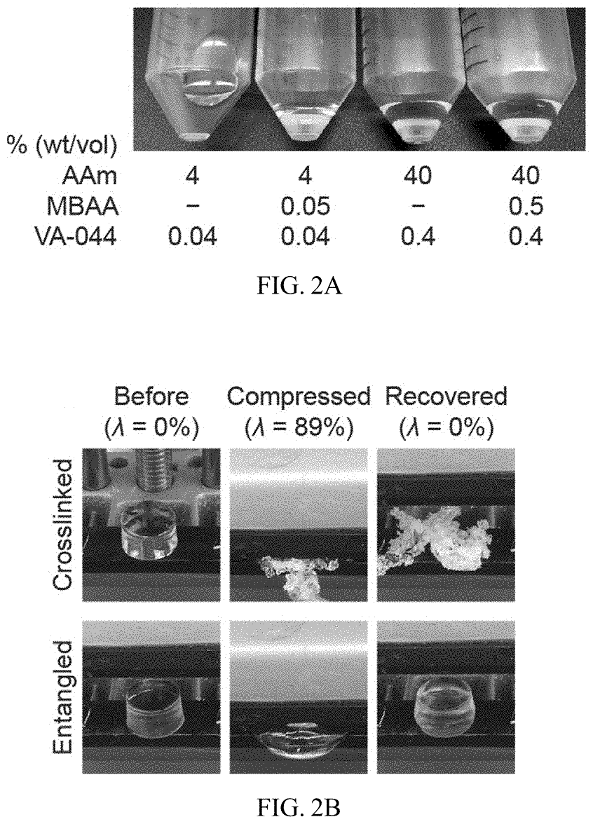

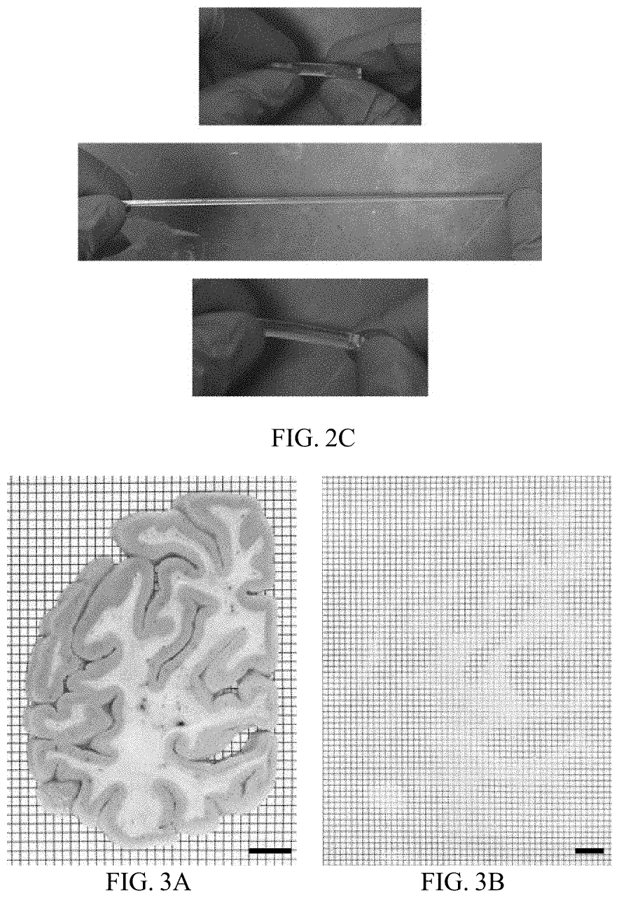

The present inventors discovered that high concentrations (20-60% [wt/vol]) of acrylamide (AAm) alone can polymerize to form an elastic hydrogel in a single synthesis step (FIG. 2A) by promoting physical chain entanglement. Notably, the concentrations of thermal initiator used in the present experiments were orders of magnitude lower than those previously reported (1 per 14,000 AAm as described herein vs. 1 per 73 AAm in CLARITY) and crosslinker (1 per 220,000 AAm as described herein vs. 1 per 170 AAm reported) to synthesize long polymer chains that naturally undergo entanglement with each other under a densely packed environment. Compared to typical pAAm gels covalently linked by high concentrations of crosslinker, N,N′-methylenebisacrylamide (MBAA) (FIG. 1A), entangled pAAm gels are formed via physical tangles between growing polymer chains, where one chain can slide onto another chain (FIG. 1B). Such slip-links offer entangled gels great flexibility and elasticity (18). The entangled pAAm gels of the present disclosure showed exceptional stability against physical stresses, such as 9-fold compression and 10-fold stretch (FIGS. 2A and 2B). FIG. 2C shows a demonstration of stretching a 36% (wt/vol) entangled pAAm gel (no MBAA and 0.005% [wt/vol] VA-044 with nitrogen gas-bubbling).

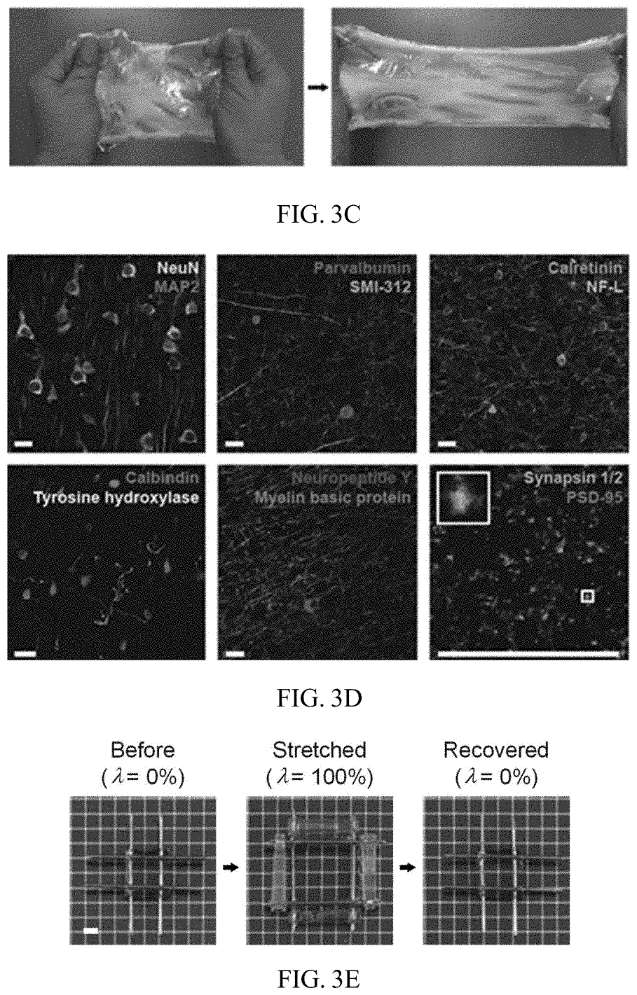

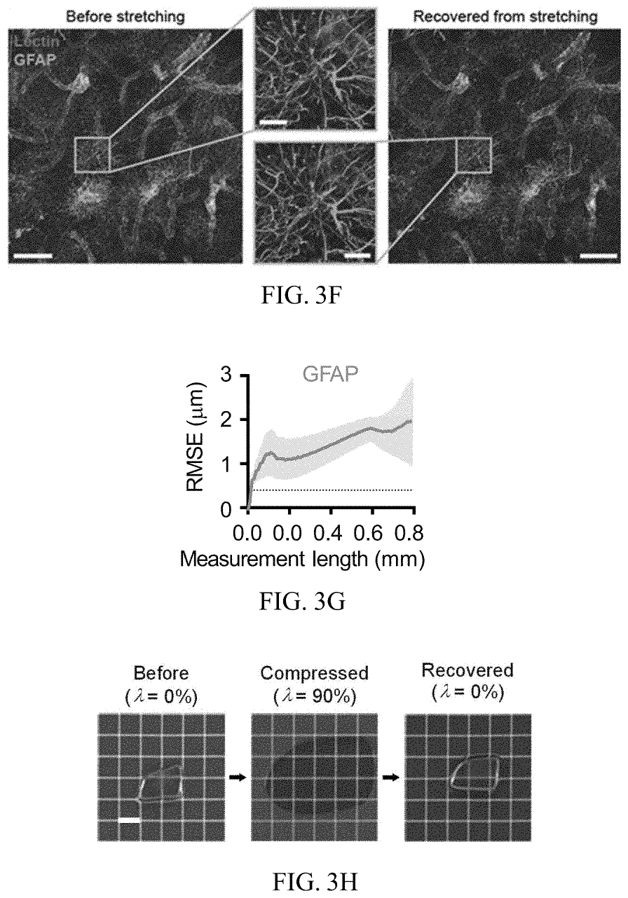

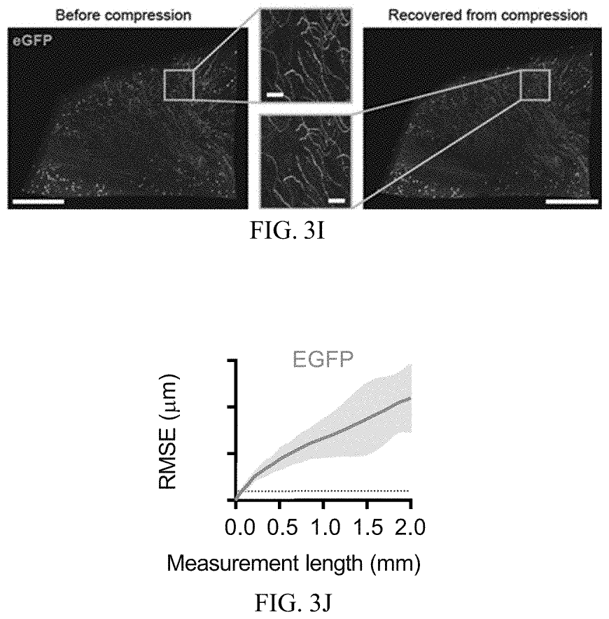

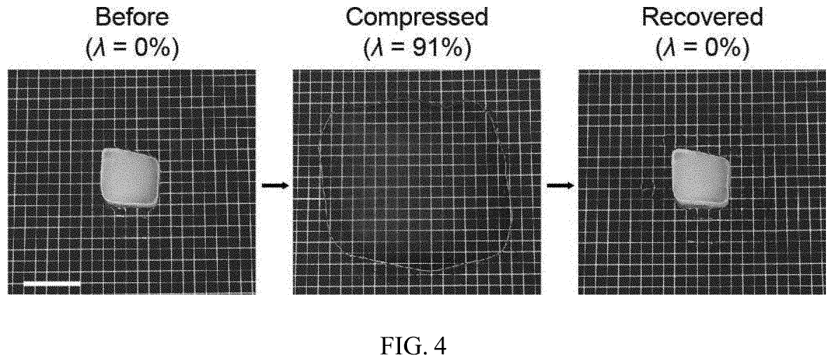

Next, it was determined if in situ synthesis of such elastic pAAm gel could transmute intact tissue into an elastic platform. To prevent any covalent crosslinking between the tissue and pAAm gel, no chemical fixatives were used during the gelling process, nor were any preconjugate acrylamides to endogenous biomolecules used. This strategy allowed for the growing pAAm chains to form purely physical entanglements with endogenous biomolecular networks that are constructed by formaldehyde fixation before gelling. It was found that this unique tissue-gel possesses the exceptional mechanical properties of entangled pAAm gels (FIG. 1C, top row). A 2 mm-thick 6 cm by 8 cm intact coronal human brain hemisphere slab was successfully processed, which produced a transparent specimen after optical clearing via refractive index (RI)-matching medium (FIGS. 3A and 3B). Elastic human tissue-gels, as well as mouse tissue-gels, were remarkably stretchable and compressible (FIG. 3C; FIG. 4). The mechanical reinforcement facilitates handling of large intact tissue samples and protects them from a variety of mechanical damages. In addition, it was confirmed that biomolecules and tissue architecture are well preserved in elastic tissue-gel (FIG. 3D). This technology to transform biological tissues into an elastic platform was termed Entangled Link-Augmented Stretchable Tissue-hydrogel (ELAST) (FIGS. 1A-1C).

ELAST allows the entangled biological networks to precisely follow the transient shape transformation of the hydrogel in a fully reversible way. After 2-fold stretching in both lateral dimensions or 10-fold axial compression, ELASTicized human and mouse brain samples showed negligible distortion (FIGS. 3E, 3F, 3H, and 3I). The distortion error was 0-3% of measured length after either stretching or compression (FIGS. 3G and 3J). Subcellular architectures, such as dendritic arbors, axonal projections, and glial processes, also remained intact (FIGS. 3F and 3I). These results demonstrate that ELAST enables fully reversible tissue shape transformation while preserving the structural and molecular information of the tissue.

These unique properties of ELAST open completely new possibilities in enhancing molecular transport inside the tissue-gel. The tissue thickness, generally the shortest dimension of a tissue, determines the time required for probe penetration. This dimensionless diffusion timescale (t) is proportional to the square of the tissue thickness (d): t=d²/D_{eff}, where De is the effective diffusivity. Therefore, it was reasoned that reducing tissue thickness by transforming its shape would significantly shorten the time required for probe penetration and labeling (FIG. 1C).

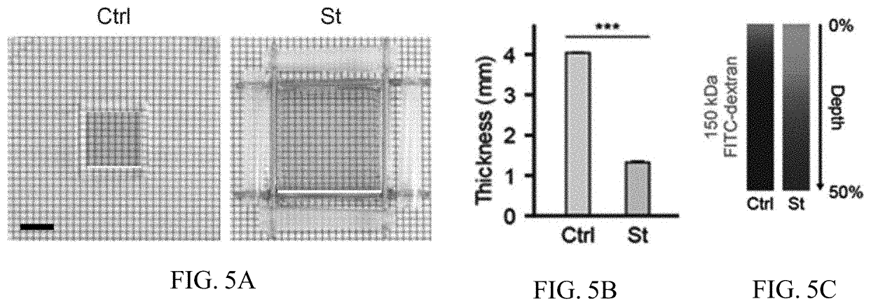

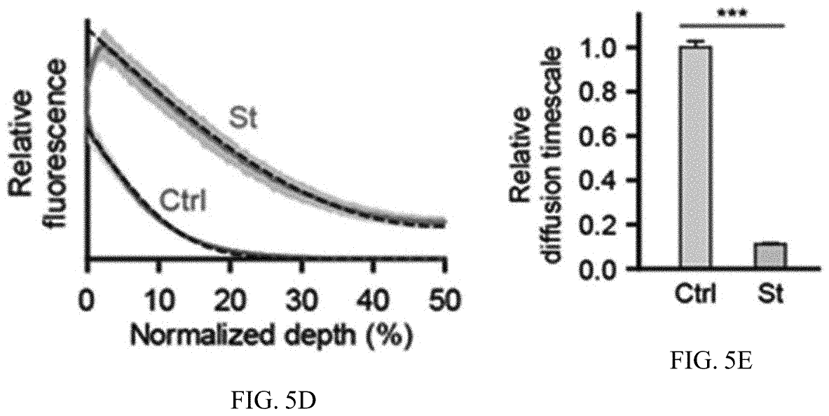

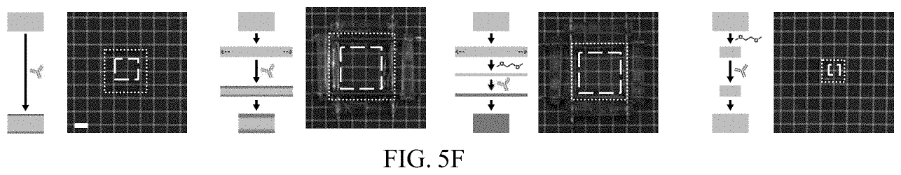

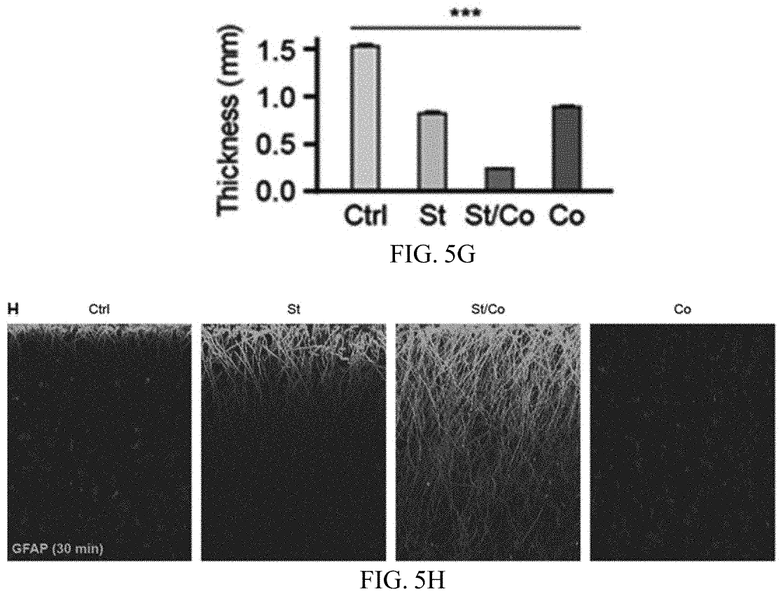

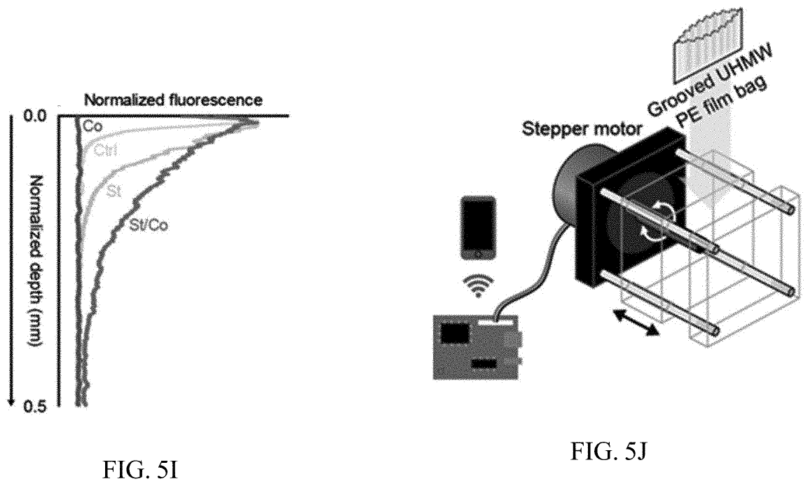

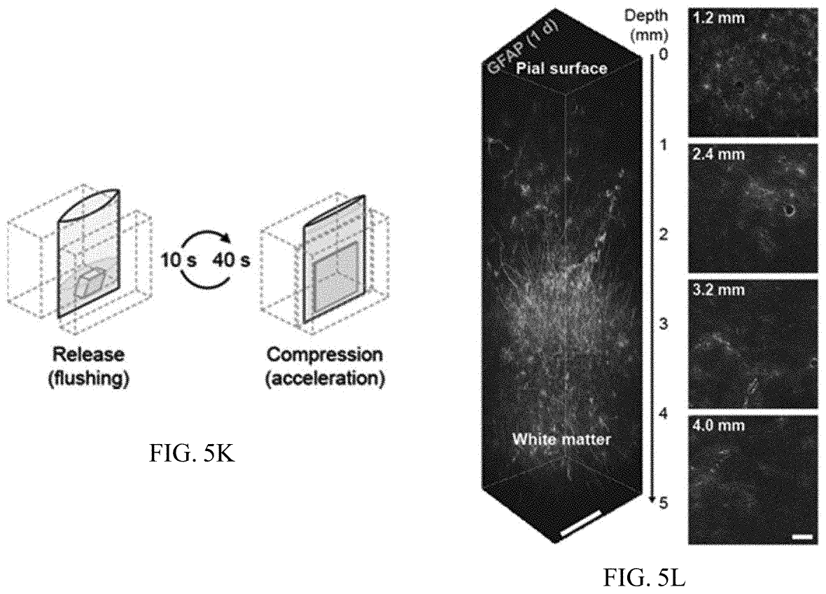

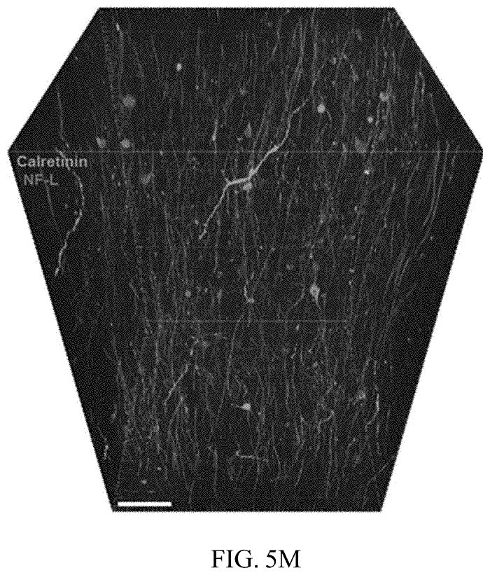

To test this directly, 4 mm-thick elastic pAAm gels were stretched in both lateral dimensions to thin them by threefold (FIGS. 5A and 5B), and were incubated in a solution containing 150 kDa dextran-dye conjugates for 45 minutes (FIGS. 5C and 5D). The dye signal profiles along the axis perpendicular to the lateral stretched plane were then measured. Fitting the signal profiles to a one-dimensional transient diffusion model confirmed that the overall threefold thinning resulted in a nine-fold decrease in diffusion timescale, as predicted (FIG. 5E). It was next tested whether thinning of ELASTicized tissues can enhance probe penetration. 1.5 mm-thick ELASTicized human brain cortical tissues were stretched to make them two times thinner and were stained with dye-conjugated glial fibrillary acidic protein (GFAP) antibodies for 30 minutes. The thinned tissues showed a fourfold increase in antibody penetration depth compared to the unstretched samples (control (Ct) and stretched (St) shown in FIGS. 5F-5I).

Additional thinning of ELASTicized tissue could further enhance probe delivery and shorten the labeling time. To test this, the possibility of chemical-mediated one-dimensional contraction of stretched tissues was explored. It was discovered that water containing 40% 1,2-dimethoxyethane, a water-miscible low-viscosity (0.46 mPa s) solvent, can isotropically contract ELASTicized tissues by 1.7-fold in each dimension (contraction (Co) shown in FIGS. 5F and 5G). When applied to stretched ELASTicized tissues, this solution showed a marked one-dimensional contraction of additional 3.4-fold thinning, making the samples thinned by 6.3-fold overall (control (Ct) and stretched (St) shown in FIGS. 5F and 5G). This synergistic two-step thinning (offering a 40-fold faster theoretical delivery) surprisingly allowed complete immunostaining of the 1.5 mm-thick ELASTicized human tissue (1.0 mm-thick before ELAST) within only 30 minutes (control (Ct) and stretched (St) shown in FIGS. 5H and 5I). This speed is orders of magnitude faster than that which was previously reported, which required 12 hours to antibody-label a 0.5 mm-thick human tissue (1). When applied to unstretched ELASTicized tissues, isotropic contraction by 40% 1,2-dimethoxyethane suppressed antibody penetration (contraction (Co) shown in FIGS. 5H and 5I). This is likely due to reduction in pore size and an increase in gel density.

Although stretching combined with chemical-mediated axial shrinkage can effectively shape-transform ELASTicized tissues to accelerate probe delivery, implementing this method is not straightforward. Stretching requires extra gel surrounding the tissue to interface with a stretching apparatus. In addition, a high concentration of 1,2-dimethoxyethane could disrupt probe target binding. These complications together could limit the utility of this approach and other approaches for sample-thinning to expedite staining were explored.

A simpler and more universal technique for sample-thinning was of interest. Instead of stretching, an ELASTicized sample was directly compressed and periodically released for solution flushing to avoid local depletion of probes. A motorized device was built to automate this cycling and a sample bag with grooved, slippery surfaces was designed to prevent sample-sticking (FIG. 5J). Using cycles of 40 second compression and 10 second release with a compressed thickness of 16% (FIG. 5K), full-thickness labeling of a 5 mm-thick human brain sample was achieved within only one day (FIG. 5L). This result demonstrates the deepest immunolabeling of an intact human tissue sample, with the shortest labeling time, to date.

Lastly, the sample-thinning approaches described herein were tested to rapidly visualize neuronal cell type and projections in the human brain (FIG. 5M). Such sparse labeling using a combination of selective macromolecular markers clearly revealed single cells with their characteristic morphologies together with the information about intercellular organizations, such as axonal directions.

In summary, the present disclosure describes a new tissue transformation technique that simultaneously enhances mechanical properties and chemical accessibility of tissue by elasticizing it. The present inventors surprisingly discovered that elastic homo-pAAm gel can be synthesized by simply promoting physical entanglement of long and densely packed pAAm chains. In situ synthesis of such an elastic gel transforms intact tissue into a deformable matrix that can be easily stretched or compressed without mechanical damage. Although all synthetic gel-based approaches rely on covalent linkage of biomolecules to pAAm to preserve tissue information, no crosslinkers were used in the present methods in order to achieve purely physical tissue-gel hybridization. Surprisingly, it was discovered that such physical hybridization not only confers high elasticity to the tissue-gel, but is also sufficient to preserve tissue architecture and biomolecules if pAAm network density is extremely high (>30 wt %).

Transient and reversible thinning of ELASTicized tissue by simple cyclic compression enables orders of magnitude faster molecular labeling than that which was previously reported in the art. This purely mechanical approach is insensitive to chemical properties of the probes and buffers used, and therefore is immediately applicable to a broad range of molecular labeling using organic dyes, oligonucleotides, enzymes, and their complexes. In addition, this approach is scalable to tissues with a wide range of lateral dimensions, from organoids (1-3 mm in diameter) to rodent organs, to intact human brain coronal blocks (up to 140 mm by 93 mm), because cyclic tissue compression only requires a compressor that is large enough to accommodate the sample.

Although probe penetration is orders of magnitude faster in thinned ELASTicized tissue, probe transport is still far slower than most probe-target binding reactions. This mismatch between the reaction timescale and transport timescale might cause a gradient in labeling intensity. To achieve uniform molecular labeling of densely expressed targets in ELASTicized thick tissues, labeling reaction kinetics would need to be simultaneously modulated using the SWITCH concept in combination with cyclic compression (19).

It is envisioned that ELAST will significantly expedite scaling of rapidly evolving tissue phenotyping approaches to larger systems by simultaneously overcoming two major bottlenecks: slow molecular labeling and low tissue integrity. For instance, the lateral dimension of human organ slices is orders of magnitude larger than that of rodent organ sections (10 mm in mouse brain vs. 140 mm in human brain), rendering human specimens much more prone to mechanical damage than animal tissues with the same thickness. ELAST not only transforms tissue into a virtually indestructible platform in regular laboratory settings, it also enables the labeling of thicker tissues at a much faster rate. Together with the versatility and simplicity of the method, ELAST will enable rapid and integrated investigation of higher animal models and clinical human samples.

### REFERENCES

1. K. Chung, J. Wallace, S.-Y. Kim, S. Kalyanasundaram, A. S. Andalman, T. J. Davidson, J. J. Mirzabekov, K. A. Zalocusky, J. Mattis, A. K. Denisin, S. Pak, H. Bernstein, C. Ramakrishnan, L. Grosenick, V. Gradinaru, K. Deisseroth, Structural and molecular interrogation of intact biological systems. Nature 497, 332-337 (2013).
2. B. Yang, J. B. Treweek, R. P. Kulkarni, B. E. Deverman, C.-K. Chen, E. Lubeck, S. Shah, L. Cal, V. Gradinaru, Single-cell phenotyping within transparent intact tissue through whole-body clearing. Cell 158, 945-958 (2014).
3. F. Chen, P. W. Tillberg, E. S. Boyden, Expansion microscopy. Science 347, 543-548 (2015).
4. E. L. Sylwestrak, P. Rajasethupathy, M. A. Wright, A. Jaffe, K. Deisseroth, Multiplexed intact-tissue transcriptional analysis at cellular resolution. Cell 164, 792-804 (2016).
5. T. Ku, J. Swaney, J.-Y. Park, A. Albanese, E. Murray, J. H. Cho, Y.-G. Park, V. Mangena, J. Chen, K. Chung, Multiplexed and scalable super-resolution imaging of three-dimensional protein localization in size-adjustable tissues. Nat. Biotechnol. 34, 973-981 (2016).
6. V. Gradinaru, J. Treweek, K. Overton, K. Deisseroth, Hydrogel-tissue chemistry: principles and applications. Annu. Rev. Biophys. 47, 355-376 (2018).
7. X. Wang, W. E. Allen, M. A. Wright, E. L. Sylwestrak, N. Samusik, S. Vesuna, K. Evans, C. Liu, C Ramakrishnan, J. Liu, G. P. Nolan, F.-A. Bava, K. Deisseroth, Three-dimensional intact-tissue sequencing of single-cell transcriptional states. Science 361, eaat5691 (2018).
8. F. Chen, A. T. Wassie, A. J. Cote, A. Sinha, S. Alon, S. Asano, E. R. Daugharthy, J.-B. Chang, A. Marblestone, G. M. Church, A. Raj, E. S. Boyden, Nanoscale imaging of RNA with expansion microscopy. Nat. Methods 13, 679-684 (2016).
9. S. Truckenbrodt, M. Maidorn, D. Crzan, H. Wildhagen, S. Kabatas, S. O. Rizzoli, X10 expansion microscopy enables 25-nm resolution on conventional microscopes. EMBO Rep. 19, e45836 (2018).
10. R. Gao, S. M. Asano, S. Upadhyayula, I. Pisarev, D. E. Milkie, T.-L. Liu, V. Singh, A. Graves, G. H. Huynh, Y. Zhao, J. Bogovic, J. Colonell, C. M. Ott, C. Zugates, S. Tappan, A. Rodriguez, K. R. Mosaliganti, S. H. Sheu, H. A. Pasolli, S. Pang, C. S. Xu, S. G. Megason, H. Hess, J. Lippincott-Schwartz, A. Hantman, G. M. Rubin, T. Kirchhausen, S. Saalfeld, Y. Aso, E. S. Boyden, E. Betzig, Cortical column and whole-brain imaging with molecular contrast and nanoscale resolution. Science 363, eaau8302 (2019).
11. Y. S. Zhang, A. Khademhosseini, Advances in engineering hydrogels. Science 356, eaaf3627 (2017).
12. Y. Okumura, K. Ito, The polyrotaxane gel: a topological gel by figure-of-eight cross-links. Adv. Mater. 13, 485-487 (2001).
13. A. Bin Imran, K. Esaki, H. Gotoh, T. Seki, K. Ito, Y. Sakai, Y. Takeoka, Extremely stretchable thermosensitive hydrogels by introducing slide-ring polyrotaxane crosslinkers and ionic groups into the polymer network. Nat. Commun. 5, 5124 (2014).
14. J. P. Gong, Y. Katsuyama, T. Kurokawa, Y. Osada, Double-network hydrogels with extremely high mechanical strength. Adv. Mater. 15, 1155-1158 (2003).
15. J. P. Gong, Materials both tough and soft. Science 344, 161-162 (2014).
16. J.-Y. Sun, X. Zhao, W. R. K. Illeperuma, O. Chaudhuri, K. H. Oh, D. J. Mooney, J. J. Vlassak, Z. Suo, Highly stretchable and tough hydrogels. Nature 489, 133-136 (2012).
17. J. Guo, X. Liu, N. Jiang, A. K. Yetisen, H. Yuk, C. Yang, A. Khademhosseini, X. Zhao, S.-H. Yun, Highly stretchable, strain sensing hydrogel optical fibers. Adv. Mater. 28, 10244-10249 (2016).
18. R. C. Ball, M. Doi, S. F. Edwards, M. Warner, Elasticity of entangled networks. Polymer 22, 1010-1018 (1981).
19. E. Murray, J. H. Cho, D. Goodwin, T. Ku, J. Swaney, S.-Y. Kim, H. Choi, Y.-G. Park, J.-Y. Park, A. Hubbert, M. McCue, S. Vassallo, N. Bakh, M. P. Frosch, V. J. Wedeen, H. S. Seung, K. Chung, Simple, scalable proteomic imaging for high-dimensional profiling of intact systems. Cell 163, 1500-1514 (2015).
20. Y.-G. Park, C. H. Sohn, R. Chen, M. McCue, D. H. Yun, G. T. Drummond, T. Ku, N. B.

Evans, H. C. Oak, W. Trieu, H. Choi, X. Jin, V. Lilascharoen, J. Wang, M. C. Truttmann, H. W. Qi, H. L. Ploegh, T. R. Golub, S. C. Chen, M. P. Frosch, H. J. Kulik, B. K. Lim, K. Chung, Protection of tissue physicochemical properties using polyfunctional crosslinkers. Nat. Biotechnol. 37, 73-83 (2019).
21. J. Wang, X. Zhou, S.-C. Chen, Study of soft tissue cutting based on a precision vibrating blade microtome. Proceedings of the Annual Meeting of the ASPE, Austin, Tex., November 2015.

### EQUIVALENTS

The foregoing written specification is considered to be sufficient to enable one ordinarily skilled in the art to practice the invention. The present invention is not to be limited in scope by examples provided, since the examples are intended as mere illustrations of one or more aspects of the invention. Other functionally equivalent embodiments are considered within the scope of the invention. Various modifications of the invention in addition to those shown and described herein will become apparent to those skilled in the art from the foregoing description. Each of the limitations of the invention can encompass various embodiments of the invention. It is, therefore, anticipated that each of the limitations of the invention involving any one element or combinations of elements can be included in each aspect of the invention. This invention is not limited in its application to the details of construction and the arrangement of components set forth or illustrated in the drawings. The invention is capable of other embodiments and of being practiced or of being carried out in various ways.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

All references, patents and patent applications that are recited in this application are incorporated by reference herein in their entirety.

1. A method of producing a tissue-hydrogel hybrid capable of reversible shape and size transformation, comprising:
(1) contacting a tissue fragment, at a temperature of about 0-4° C. for about 1-10 days, with
(a) a high concentration of a hydrogel monomer,
(b) a low concentration of thermal or radical initiator, and
(c) a low concentration of crosslinker; and
(2) increasing the temperature to a temperature in the range of about 1-30° C. for about 2 hours to 1 day, and removing oxygen.

2. The method of claim 1, wherein
(a) the hydrogel monomer is an acrylic monomer, and/or
(b) the thermal initiator is VA-044, and/or
(c) the crosslinker is N,N′-methylenebisacrylamide (MBAA), and/or
(d) the hydrogel monomer is an acrylamide monomer.

3. The method of claim 1, wherein
(a) the hydrogel monomer is present at a concentration of about 20-60% weight/volume, or
(b) the hydrogel monomer is present at a concentration of about 40% weight/volume.

4. The method of claim 1, wherein
(a) the thermal initiator:hydrogel monomer ratio is 1:14,000, and/or
(b) the crosslinker:hydrogel monomer ratio is 1:220,000.

5. The method of claim 1, wherein
(a) the hydrogel monomer is acrylamide monomer and is present at 40% (wt/vol), and
(b) the thermal initiator is VA-044 and is present at 0.005% (wt/vol), and
(c) the crosslinker is MBAA and is present at 0.5% (wt/vol).

6. The method of claim 1, wherein
(a) the hydrogel monomer is acrylamide monomer and is present at 30% (wt/vol), and
(b) the thermal initiator is VA-044 and is present at 0.01% (wt/vol), and
(c) the crosslinker is MBAA and is present at 0.003% (wt/vol).

7. The method of claim 1, wherein the tissue fragment is:
(a) about 2-5 mm thick, with lateral dimensions of 6 cm by 8 cm, and/or
(b) about 2 mm thick, with lateral dimensions of 6 cm by 8 cm.

8. The method of claim 1, wherein the tissue fragment is a human tissue fragment, optionally a heart, colon or brain tissue fragment, optionally a cerebral organoid.

9. The method of claim 1, further comprising permeabilizing the tissue fragment prior to step (1).

10. The method of claim 1, wherein
(a) the tissue is not contacted with paraformaldehyde during steps (1) and (2), and/or
(b) the tissue fragment is contacted with formaldehyde before step (1).

11. The method of claim 9, wherein the tissue fragment is permeabilized prior to step (1) by contacting the tissue fragment with a detergent at a concentration of greater than about 0.5% wt/vol, at a temperature in the range of 20−80° C., for about 1-10 days.

12. The method of claim 9, wherein
(a) the detergent is a non-ionic detergent, and/or
(b) the detergent is sodium dodecyl sulfate (SDS).

13. A tissue-hydrogel hybrid comprising
a tissue fragment comprising
(a) about 20-60% (wt/vol) hydrogel monomer, and
(b) a thermal initiator, in a thermal initiator:hydrogel monomer ratio of 1:14,000, and
(c) a crosslinker, in a crosslinker:hydrogel monomer ratio of 1:220,000.

14. The tissue-hydrogel hybrid of claim 13, having
(a) about 9-fold compression ability and/or about 10-fold stretching ability, and/or
(b) about 0-3% distortion error after either stretching or compression.

15. The tissue-hydrogel hybrid of claim 13, wherein
(a) the hydrogel monomer is an acrylic monomer, and/or
(b) the hydrogel monomer is an acrylamide monomer, and/or
(c) the thermal initiator is VA-044, and/or
(d) the crosslinker is MBAA.

16. A method of labeling a tissue fragment with a probe, comprising
contacting a tissue-hydrogel hybrid of claim 13, with a probe, while the tissue hydrogel is repeatedly reversibly stretched, in the range of 2-10-fold, and allowed to regain its original size and shape, for a period of time sufficient for the probe to diffuse throughout the tissue-hydrogel hybrid.

17. The method of claim 16, further comprising allowing the tissue-hydrogel hybrid to regain its original size and imaging the tissue-hydrogel hybrid to visualize bound probe, optionally wherein imaging is fluorescent microscopy imaging.

18. The method of claim 16, wherein the tissue-hydrogel hybrid is reversibly stretched by placing it between two parallel plates and moving the plates towards each other, thereby stretching the tissue-hydrogel hybrid in the x and y dimensions and decreasing the tissue hydrogel in the z dimension.

19. The method of claim 16, wherein the probe is (a) a quantum dot, a peptide, a protein, or a nucleic acid, or
(b) a protein comprising an antibody or antibody fragment.

20. A method of labeling a tissue fragment with a probe, comprising
contacting a tissue-hydrogel hybrid produced by the method of claim 1, with a probe, while the tissue hydrogel is repeatedly reversibly stretched, in the range of 2-10-fold, and allowed to regain its original size and shape, for a period of time sufficient for the probe to diffuse throughout the tissue-hydrogel hybrid.
